(19) United States
(12) Patent Application Publication
(10) Pub. No.: US 2025/0320570 A1
(43) Pub. Date: Oct. 16, 2025

(54) METHOD AND APPARATUS FOR METALS, ALLOYS, MATTES, OR ENRICHED AND CLEANED SLAGS PRODUCTION FROM PREDOMINANTLY OXIDE FEEDS

(71) Applicant: Hertha Metals, Inc., Conroe, TX (US)

(72) Inventors: Laureen MEROUEH, Brownsville, TX (US); Robert Leslie STEPHENS, Rossland, CA (US)

(21) Appl. No.: 19/248,152

(22) Filed: Jun. 24, 2025

Related U.S. Application Data
(63) Continuation of application No. 18/357,040, filed on Jul. 21, 2023.
(60) Provisional application No. 63/391,679, filed on Jul. 22, 2022.

(51) Int. Cl. C21C 5/52

(52) U.S. Cl. CPC C21C 5/5217; C21C 5/5205; C21C 5/5264

(57) ABSTRACT

Described are steel production systems and methods, and a furnace and methods of using such furnace to produce steel. In some embodiments, the furnace may include a shell having a top portion and a bottom portion. There may be a roof connected to the top portion that can have feed ports for the introduction of a metal oxide into the furnace. The shell may include injectors that can inject a fluid into the furnace. The bottom portion may be connected to a hearth. The furnace can melt the metal oxide to form a molten bath in the hearth. The molten bath may have a slag layer and a metal layer. The fluid can reduce the metal oxide in the slag layer to form molten metal.

### CROSS-REFERENCE TO RELATED APPLICATIONS

This application is a continuation of U.S. patent application Ser. No. 18/357,040, entitled “Method and Apparatus for Metals, Alloys, Mattes, or Enriched and Cleaned Slags Production from Predominantly Oxide Feeds,” filed Jul. 21, 2023, which claims priority to and the benefit of U.S. Provisional Application No. 63/391,679, entitled “Method and Apparatus for Metals, Alloys, Mattes, or Enriched and Cleaned Slags Production from Predominantly Oxide Feeds,” filed Jul. 22, 2022, the entire contents of each of which is hereby incorporated by reference.

### FIELD

This disclosure relates generally to metals, alloys including steel and ferroalloys, mattes, and enriched or cleaned slags production from predominantly oxide feeds and methods of producing metals, alloys, mattes, and enriched and cleaned slags, and more specifically, to an integrated process with a smelting reduction furnace and methods of using such furnace to produce metals, alloys, mattes, and enriched and cleaned slags with reduced CO2 emissions compared to coal-based processes.

### BACKGROUND

Predominantly oxide feeds, which are sometime in molten form, are used as feedstocks to produce a number of metals, alloys, mattes, and enriched or cleaned slags. Metals produced from oxide and/or carbonate feeds include tin, lead, iron, chrome and silicon. Alloys produced from oxide and/or carbonate feeds include steel, ferroalloys like ferrochrome, ferronickel, and ferrosilicon, and nonferrous alloys like brass and bronze. Mattes produced from oxide and/or carbonate feeds include copper, nickel, and cobalt mattes for subsequent processing. Enriched and cleaned slags produced from oxide and/or carbonate feeds include titania slags for subsequent production of titanium dioxide powders and slags from oxidizing processes like flash smelting for copper and nickel production or steelmaking processes or highly reducing slag fuming processes.

As an example of existing processes for the production of steel from predominantly oxide feeds, primary steel is primarily produced by converting agglomerated iron ore to molten carbon-excess pig iron, or hot metal, through a blast furnace (BF), which is then converted into steel through a basic oxygen furnace (BOF) and subsequent ladle metallurgy refinement steps prior to casting. Roughly 75% of steel is produced through the route of blast furnaces and basic oxygen furnaces, and results in approximately 1.85 tonnes of CO₂ per tonne of crude steel (t_{co2}/t_{cs}) to 2.2 t_{co2}/t_{cs}. The production of steel produces approximately 11% total global CO₂ emissions. The conversion of iron ore to liquid steel through the BF-BOF route requires five steps, including coke manufacturing, preparation of iron ore through sintering or pelletizing. The blast furnace is the most carbon-intensive step in primary steelmaking. In a separate step, coal is converted into metallurgical coke, which is then introduced into the blast furnace to reduce the iron ore and provide the necessary heat for melting through combustion with hot air blown into the furnace. At the bottom of the blast furnace, carburized molten metallic iron collects as well as the slag which floats on the metallic iron. The slag layer consists of the gangue elements present in the iron ore. While hydrogen can be injected into blast furnaces to displace some of the coke, the process is not optimized for hydrogen direct reduction, resulting in low hydrogen utilization, minimal reduction in CO₂ emissions (of roughly 20%), and significant negative effects on the BF thermal profiles. The downstream BOF process reduces the carbon content of the hot metal from the BF from 3-4% to 1% by injecting high-purity oxygen into the hot metal, removes undesired impurities and refines the pig iron and ferrous scrap into steel to reached the required composition.

An alternative technology for the production of virgin iron is the Direct Reduction of Iron (DRI) in a shaft furnace or fluidized bed reactor, using carbon monoxide and hydrogen as the reducing gases mixture. Typically, the reducing gas mixture source is natural gas or coal. Iron ore pellets or iron ore fines, depending on the particular DRI process, are directly reduced in the solid-state in the DRI reactor. The reaction temperatures in the DRI process are well below the melting point of iron, and typically below about 800°° C. to avoid sintering and issues with agglomeration of the iron ore pellets. The process results in sponge iron, a highly reactive and porous solid product, which must then either be used in an adjacent steel production process to avoid excessive reoxidation or briquetted while still hot to produce Hot Briquetted Iron (HBI) that can be shipped globally.

Work is underway to commercialize the replacement of the carbon monoxide—hydrogen gas mixture with pure hydrogen in the DRI process, although most technologies seek to include some carbon monoxide or carbon source such as natural gas and methane to exothermically provide heat to the endothermic molecular hydrogen reaction with iron oxide and/or to at least partially carburize the DRI/HBI product, such that the carbon provides “fuel’ for partial downstream removal to make steel.

DRI/HBI must be melted and converted into steel through either a BOF or an Electric Arc Furnace (EAF). The EAFs use an electric arc to melt the charged materials, such as DRI/HBI and/or cast pig iron ingots (or pigs), and scrap steel, and then keep the top slag layer and bottom metal layer molten during subsequent refining to produce steel. EAFs are typically used to process ferrous scrap into secondary steel, and DRI/HBI or cast pig iron is used to dilute impurities in the ferrous scrap that limit the steel grades to be produced in secondary steelmaking. However, some EAFs are now using mostly DRI/HBI and some cast pig iron to make higher quality steels for more demanding applications. For DRI/HBI to be compatible with existing EAF processes and technology, high-grade iron ore, generally containing 65+% iron, must be used in the DRI process, limiting the amount of gangue elements present in the DRI/HBI. In DRI, the gangue elements, such as silicon and aluminum in the form of oxides, are not removed as a separate slag phase as in the BF or BOF since the process occurs in the solid state. Also, the extent of metallization of the iron in the DRI is generally limited to approximately 90% and the remaining unreduced iron remains in the DRI as wüstite (FeO), which also forms slag when melted. Therefore, in the consequent molten phase oxidizing processes that occurs in the EAF or BOF, very high volumes of slag are produced if the DRI contains elevated levels of gangue, and since the slag contains high levels of FeO due to the chemical equilibrium between the steel being produced through oxidation of the carbon in the iron-based phase and the slag.

In recent times, the addition of melting furnaces, such as the large submerged-arc furnaces (SAFs) used at New Zealand Steel, between a DRI process and EAF or BOF has been proposed. This additional furnace melts the DRI and separates the gangue elements and remaining unreduced FeO from the metallic iron. To produce a molten pig iron amendable to existing steelmaking processes and a slag low in iron, a sufficient quantity of reductant must be added to the melting furnace. The reductant is currently some form of solid carbon. This carbon is then mostly blown out of the pig iron to form steel, resulting in GHG emissions.

As an example of existing processes for the production of metal from predominantly oxide feeds, tin concentrate comprising mostly cassiterite is reductively smelted to produce crude tin and discard slag using a multistage process with smelting, slag reduction, and slag fuming stages. Top-Submerged Lance (TSL) furnaces are the predominant technology for tin production, having replaced reverberatory and electric smelting furnace technologies. Silicon metal and a number of ferroalloys are produced by the smelting reduction of predominantly oxide feeds in large EAFs. Some of these processes include calcining and/or prereduction steps ahead of the EAFs. Ferrochrome production is moving from Alternating-Current (AC) furnace technologies (usually operated in either submerged or brush arc modes) to Direct-Current (DC) furnaces due to the increase in chrome recovery when reductively smelting chromite ore in a DC furnace. Mattes are typically produced in smelting reduction furnaces when processing either slightly sulfurized ore as done with some nickel laterite smelting in Indonesia, when smelting calcined concentrates that have residual sulfur content or when reducing slags with elevated copper, nickel, or cobalt contents from upstream oxidizing pyrometallurgical processes. Titanium ores can be upgraded by the removal of iron in reductive smelting processes after ore preheating and reductive char formation in rotary kilns as practiced in Canada, South Africa, Norway, and China. Molten slags can also be cleaned either by reducing dissolved oxide species into a molten collection phase beneath the slag or by reducing or evaporating dissolved oxide species into the furnace freeboard gas phase above the slag. Examples include reducing slags with elevated cobalt or silver contents and reducing slags with elevated zinc, lead, and tin respectively.

The Hydrogen Plasma Smelting Reaction (HPSR) described herein is a smelting reduction reaction that produces a molten alloy, matte, or vapor phase from a metal oxide mixture, or a mixture of mostly metal oxides with some sulfur content, by harnessing ionized hydrogen and the high temperatures of a hydrogen plasma as well as molecular hydrogen gas injected into the molten slag layer or molten phase beneath the molten slag. The ionized hydrogen and molecular hydrogen gas create highly reducing conditions in the molten slag, and/or surrounding environment, allowing a number of chemical reduction reactions to occur. These reactions may not be as favorable in the presence of molecular hydrogen, while ionized hydrogen shifts the Gibbs Free Energy of the reaction to more favorable thermodynamic conditions. Furthermore, the main furnace described herein contains embodiments in which an electric arc is used to generate thermal energy for smelting, as molecular hydrogen and/or hydrogen plasma are used for the reduction reaction of metal oxides.

When applied to steel production, HPSR contributes to a method of producing steel from iron ore with minimal CO₂ emissions by harnessing the ionized state of hydrogen to reduce the iron ore. Compared to the reduction of iron ore with neutral species (e.g., molecular hydrogen through DRI), the reduction potential of hydrogen ions is 3 to 15 times higher. The reduction of iron ore through hydrogen plasma and/or molecular hydrogen allows for a simplified process, with the option to produce molten steel from iron ore within a single furnace eliminating two separate steps for reduction and refining, and eliminating the need for pre-agglomeration, pelletizing or upgrading of iron ore. The HPSR furnaces developed thus far inject hydrogen gas through a plasma torch, through the upper furnace shell into the surrounding gas environment or through the center of an electrode. The existing HPSR furnaces also introduce the iron ore through the center of the electrode for in-flight reduction, or in a batchwise process to the bottom of the furnace, which limits the surface area of the reduction reaction and therefore throughput of the process.

### SUMMARY

This disclosure relates to the production of metals, alloys, mattes, and enriched or cleaned slags, including production of the aforementioned metals and alloys (e.g. copper, iron, steel, ferrochrome, nickel, etc.). Described herein are furnaces and methods of using such furnaces to produce steel, though the method can be applied to produce other alloys, metals, mattes and cleaned slags, as will be appreciated by one skilled in the field. Fine, sinters, or lump iron ore or metal oxides can be added to the furnace from one or more feed ports on a roof of the furnace and/or the walls (e.g., shell) of the furnace. The feed ports can be located adjacent to electrodes as well as around the circumference of the roof. This configuration can help align zones of high temperature in the furnace with the feed paths of the iron ore or metal oxides, which can lead to improved productivity and reduced operational costs, and aid in protecting the furnace walls from the arc radiation and splashing of the molten pool. In some embodiments, the furnace can operate with continuous tapping or batch tapping, thus increasing energy efficiency. In some embodiments, the components of the furnace described herein can be compatible with a commercial EAF such that an EAF can be retrofitted with these components to perform HPSR and/or molecular hydrogen reduction reactions.

In some embodiments, a reducing fluid (e.g., hydrogen) can be injected through or near the electrode for hydrogen plasma production. In some embodiments, hydrogen can be injected and/or bubbled through the bottom of the furnace. In some embodiments, hydrogen can enter through supersonic or coherent jets located on the top and sides of the furnace. In some embodiments, hydrogen can enter a slag and molten metal bath region of the furnace where a reduction reaction can take place. These modes of hydrogen injection can increase the reduction reaction area and generate bath stirring, which can increase reduction reaction rates and can increase hydrogen utilization. Upon injection of the hydrogen into the metal layer and/or slag layer, the jet of hydrogen can diffuse into hydrogen bubbles. The mode of hydrogen injection can be selected to maximize the dispersion of the hydrogen bubbles, optimize the hydrogen bubble diameter to increase the reduction reaction surface area between the metal oxide and hydrogen, and/or optionally create a foamy slag, such that the volume in which the reduction reaction occurs is maximized. Additionally, generation of a foamy slag through hydrogen injection can protect the furnace roof from radiation from the molten bath, thereby reducing heat losses from the system. In some embodiments, the injected molecular hydrogen or hydrogen mixtures create a partial hydrogen atmosphere in the furnace. At the electric arc, the hydrogen is ionized, generating a hydrogen plasma that may participate in the reduction reaction of the metal oxides.

In some embodiments, a furnace for molten metal production includes: a shell or plurality of walls having a top portion and a bottom portion, and the shell or plurality of walls comprises a plurality of injectors configured to inject a fluid into the furnace; a roof connected to the top portion of the shell or plurality of walls, and the shell, plurality of walls and/or roof comprises a plurality of feed ports configured to introduce a metal oxide to the furnace; and a hearth connected to the bottom portion of the shell or plurality of walls, and the furnace is configured to melt the metal oxide to form a molten bath including a slag layer that includes molten metal oxide and a metal layer that includes molten metal below the slag layer, and the fluid reduces the molten metal oxide in the slag layer to molten metal. In some embodiments, the plurality of injectors is configured to inject the fluid towards a working area of the molten bath, and metal oxide is present. In some embodiments, a first injector of the plurality of injectors is configured to inject fluid towards an area of the molten bath. In some embodiments, a second injector of the plurality of injectors is configured to inject fluid towards a second area of the molten bath different from the first area of the molten bath. In some embodiments, at least one of the plurality of injectors is configured to inject the fluid into the molten bath. In some embodiments, the at least one of the plurality of injectors is configured to inject the fluid into the slag layer of the molten bath. In some embodiments, the at least one of the plurality of injectors is an injector submerged in the molten bath. In some embodiments, the at least one of the plurality of injectors is an injector submerged in the slag layer. In some embodiments, the at least one of the plurality of injectors is an injector submerged in the molten bath in contact with both the slag and metal layers. In some embodiments, the shell or plurality of walls has an internal axis and the plurality of injectors is configured to inject fluid at an angle less than 90 degrees with respect to a line that is tangent to each injector of a cross section of the shell or plurality of walls perpendicular to the internal axis. In some embodiments, the roof includes a second plurality of injectors configured to inject fluid into the furnace. In some embodiments, the plurality of injectors is configured to inject fluid such that the fluid agitates the slag layer and/or metal layer in the furnace. In some embodiments, the plurality of injectors is configured to inject fluid such that slag layer and/or metal layer of the molten bath swirls within the furnace. In some embodiments, the plurality of injectors is spaced equidistant around a circumference of the shell or plurality of walls. In some embodiments, the fluid includes hydrogen gas, hydrogen-containing gases, carbon-containing gases, or combinations thereof. In some embodiments, the plurality of injectors includes at least one of lances, submerged tuyeres, swirling lances such as top-submerged-lance, supersonic jets, coherent jets, plasma torches, or any type of injector which maximizes the contact area between the injected fluid and slag layer. In some embodiments, the plasma torch injects fluid at a temperature greater than the melting point of the metal oxide. In some embodiments, the coherent jets include at least one of supersonic coherent jets, subsonic coherent jets, or coherent jets with shrouded flames. In some embodiments, the roof includes at least one electrode that extends from the roof towards the hearth of the furnace and the hearth comprises at least one opposite electrode, and the furnace is configured to generate an electric arc between a distal end of the at least one electrode and the at least one opposite electrode. In some embodiments, the electric arc is between the distal end of the at least one electrode and the molten bath of the furnace. In some embodiments, the distal end of the at least one electrode is above the slag layer of the molten bath. In some embodiments, the distal end of the at least one electrode is submerged in the slag layer and/or metal layer of the molten bath. In some embodiments, the at least one opposite electrode is embedded within the hearth. In some embodiments, the electric arc is a transferred or non-transferred electric arc. In some embodiments, the electric arc is configured to melt the metal oxide. In some embodiments, the at least one electrode is a cathode and the at least one opposite electrode is an anode at any given time, under either alternating current or direct current electrical operation. In some embodiments, the at least one electrode comprises a port running through a central axis of the at least one electrode. In some embodiments, the fluid is injected into the furnace through the port of the at least one electrode. In some embodiments, the electrode is a solid and the fluid is solely injected through the plurality of injectors. In some embodiments, at least a portion of the fluid injected into the furnace passes through the electric arc forming a plasma. In some embodiments, the plasma melts the metal oxide, keeps the metal layer and slag layer in the molten phase, supplies thermal energy to the furnace, supplies ionized gas to the bath, and/or reduces the metal oxide. In some embodiments, the roof comprises multiple electrodes that extend from the roof towards the hearth of the furnace, and the furnace is configured to generate an electric arc between a distal end of each electrode of the multiple electrodes and the at least one opposite electrode. In some embodiments, a distance between the multiple electrodes is such that there is not any arc interference between the electric arc of each electrode and the at least one opposite electrode. In some embodiments, a distance between the multiple electrodes is such that there is arc interference between the electric arc of each electrode and the at least one opposite electrode, such that the arcs merge towards the center of the bath. In some embodiments, the at least one electrode and/or at least one opposite electrode comprises graphite, titanium, tungsten, tantalum, zirconium, or copper. In some embodiments, the electric arc agitates the molten bath. In some embodiments, the plurality of feed ports are configured such that feed ports closer to a center of the roof introduce more metal oxide to the furnace than feed ports further from the center of the roof. In some embodiments, the applicability of the metal oxide to the method is dictated by the thermodynamic potential for reduction by the injected fluid and/or ionized fluid, such as iron oxides, chrome oxides, nickel oxides, copper oxides, and phosphorous oxides in the embodiments in which ionized hydrogen and/or molecular hydrogen are present. In some embodiments, the metal oxide includes iron oxide, hematite, magnetite, or combinations thereof. In some embodiments, the molten metal comprises metallic iron. In some embodiments, the shell or plurality of walls includes at least one heat exchanger. In some embodiments, the at least one heat exchanger includes water cooling. In some embodiments, the shell or plurality of walls includes water-cooled copper. In some embodiments, an interior of the shell or plurality of walls includes a castable refractory lining or state-of-the art technology for enhancing furnace integrity. In some embodiments, the plurality of injectors is configured to inject a fluxing source or metal oxide into the furnace. In some embodiments, the fluid is injected in combination with a solid such as fluxes or fine metal oxide, and the flux or injected metal oxide serves as bubble nucleation points for the injected gas to increase the surface area of a reaction between the fluid and the metal oxide in the slag layer. In some embodiments, the plurality of injectors is configured to inject a carbon source into the furnace. In some embodiments, the carbon source is a solid carbon source. In some embodiments, the solid carbon source is injected into the metal bath for carburization. In some embodiments, carburization of the molten metal is performed in a downstream ladle metallurgy process.

In some embodiments, a method of forming a molten metal includes: introducing a metal oxide or a metallic mixture into a furnace through a plurality of feed ports in a roof and/or side of the furnace; melting the metal oxide in the furnace to form a molten bath including a slag layer that includes molten metal oxide and a metal layer that includes molten metal below the slag layer; introducing a fluid into the furnace through a plurality of injectors in a side of the furnace, and the fluid reduces the molten metal oxide in the slag layer to molten metal. In some embodiments, the fluid is introduced towards an adjacent injector and/or adjacent working area. In some embodiments, the fluid is introduced towards an adjacent injector and/or adjacent working area. In some embodiments, the fluid is introduced into the molten bath. In some embodiments, the fluid is introduced into the slag layer of the molten bath. In some embodiments, the fluid is introduced into the metal layer of the molten bath, and the metal layer has a lower viscosity than the slag layer and therefore results in decreased bubble diameter formed from the injected fluid. In some embodiments, the fluid is introduced at an angle less than 90 degrees with respect to a line that is tangent to each injector of a cross section of the shell or plurality of walls perpendicular to an internal axis. In some embodiments, the fluid is introduced such that the fluid agitates the molten bath in the furnace to create a homogenous slag composition and enhance separation of metallics contained in the slag such that the metallics collect in the metal layer below the slag layer. In some embodiments, the fluid is introduced such that the molten bath swirls within the furnace. In some embodiments, the plurality of injectors is spaced equidistant around a circumference of the shell or plurality of walls. In some embodiments, the fluid comprises hydrogen gas. In some embodiments, the method includes generating an electric arc between a distal end of at least one electrode that extends from the roof of the furnace towards the bottom of the furnace and at least one opposite electrode at the bottom of the furnace, and the electric arc is configured to melt the metal oxide or provide thermal energy to the bath. In some embodiments, the electric arc is between the distal end of the at least one electrode and the molten bath of the furnace. In some embodiments, the method includes introducing the fluid into the furnace through a port running through a central axis of the at least one electrode. In some embodiments, the method includes generating a plasma from the introduced fluid and the electric arc. In some embodiments, the electric arc agitates the molten bath. In some embodiments, the method includes introducing more metal oxide into the furnace through feed ports closer to a center of the roof than feed ports further from the center of the roof. In some embodiments, the metal oxide comprises iron ore. In some embodiments, the metal oxide includes iron oxide, hematite, magnetite, iron oxide-containing waste streams, or combinations thereof. In some embodiments, the iron ore is in the form of fines, lumps, pellets, sinter and/or metal oxide mixture. In some embodiments, the molten metal includes metallic iron. In some embodiments, the method includes introducing a carbon source into the furnace through the plurality of feed ports and/or through the plurality of injectors. In some embodiments, the carbon source is a solid carbon source, used to carburize the metallic iron. In some embodiments, any fluid injected into the slag layer partially escapes without reducing the iron ore. In some embodiments, the fluid that escapes from the slag layer generates a plasma around the electric arc. In some embodiments, ionized fluid around the electric arc is sucked into the slag layer by arc momentum. In some embodiments, the ionized fluid reduces the metal oxide in the slag layer near the arc. In some embodiments, the ionized fluid around the electric arc becomes un-ionized, exothermically contributing to heat generation in the furnace. In some embodiments, the furnace is a DC or AC electric arc furnace. In some embodiments, the method operates in a batch, continuous, or semi-continuous mode. In some embodiments, the metal is continuously tapped and the high metal oxide-containing slag can be batch-wise processed by increased fluid injection to reduce the metal oxide in the slag. In some embodiments, a first furnace produces a high metal-oxide containing slag and metal layer and a second furnace is in communication with the first furnace to receive the slag. In some embodiments, the second furnace includes the method to reduce the metal oxide contained in the slag. In some embodiments, the reduction reaction is primarily operated at high levels of metal oxide in the slag layer to enhance the hydrogen utilization of the process. In some embodiments, before the slag is tapped, increased injection of the reductant occurs to lower the levels of the metal oxide in the slag prior to tapping.

In some embodiments, a furnace for molten metal production includes: a shell or plurality of walls having a top portion and a bottom portion, wherein the shell or plurality of walls comprises a plurality of injectors configured to inject a fluid into the furnace; a roof connected to the top portion of the shell or plurality of walls, wherein the shell or plurality of walls and/or roof comprises a plurality of feed ports configured to introduce a molten metal oxide to the furnace; and a hearth connected to the bottom portion of the shell or plurality of walls, wherein the furnace is configured to maintain the molten metal oxide in its molten state and the fluid reduces the molten metal oxide to molten metal. In some embodiments, the plurality of injectors is configured to inject the fluid towards the molten metal oxide. In some embodiments, a first injector of the plurality of injectors is configured to inject fluid towards an area of the molten metal oxide. In some embodiments, a second injector of the plurality of injectors is configured to inject fluid towards a second area of the molten metal oxide different from the first area of the molten metal oxide. In some embodiments, at least one of the plurality of injectors is configured to inject the fluid into the molten metal oxide. In some embodiments, the at least one of the plurality of injectors is an injector submerged in the molten metal oxide. In some embodiments, at least one of the plurality of injectors is an injector submerged in the molten metal. In some embodiments, the at least one of the plurality of injectors is an injector submerged in contact with both the molten metal oxide and molten metal. In some embodiments, the shell or plurality of walls has an internal axis and the plurality of injectors is configured to inject fluid at an angle less than 90 degrees with respect to a line that is tangent to each injector of a cross section of the shell or plurality of walls perpendicular to the internal axis. In some embodiments, the roof comprises a second plurality of injectors configured to inject fluid into the furnace. In some embodiments, the plurality of injectors is configured to inject fluid such that the fluid agitates the molten metal oxide and/or molten metal in the furnace. In some embodiments, the plurality of injectors is configured to inject fluid such that the molten metal oxide and/or molten metal swirls within the furnace. In some embodiments, the plurality of injectors is spaced equidistant around a circumference of the shell or plurality of walls. In some embodiments, the fluid comprises hydrogen gas, hydrogen-containing gases, carbon-containing gases, or combinations thereof. In some embodiments, the plurality of injectors comprises at least one of lances, submerged tuyeres, swirling lances such as top-submerged-lance, supersonic jets, coherent jets, plasma torches, or any type of injector which maximizes the contact area between the injected fluid and slag layer. In some embodiments, the plasma torch injects fluid at a temperature greater than the melting point of the metal oxide. In some embodiments, the coherent jets comprises at least one of supersonic coherent jets, subsonic coherent jets, or coherent jets with shrouded flames. In some embodiments, the roof comprises at least one electrode that extends from the roof towards the hearth of the furnace and the hearth comprises at least one opposite electrode, wherein the furnace is configured to generate an electric arc between a distal end of the at least one electrode and the at least one opposite electrode. In some embodiments, the electric arc is between the distal end of the at least one electrode and the molten metal oxide and/or molten metal of the furnace. In some embodiments, the distal end of the at least one electrode is above the molten metal oxide. In some embodiments, the distal end of the at least one electrode is submerged in the molten metal oxide and/or molten metal. In some embodiments, the at least one opposite electrode is embedded within the hearth. In some embodiments, the electric arc is a transferred or non-transferred electric arc. In some embodiments, the at least one electrode is a cathode and the at least one opposite electrode is an anode at any given time, under either alternating current or direct current electrical operation. In some embodiments, the at least one electrode comprises a port running through a central axis of the at least one electrode. In some embodiments, the fluid is injected into the furnace through the port of the at least one electrode. In some embodiments, the electrode is a solid and the fluid is solely injected through the plurality of injectors. In some embodiments, at least a portion of the fluid injected into the furnace passes through the electric arc forming a plasma. In some embodiments, the plasma keeps the molten metal oxide and/or molten metal in its molten state, supplies thermal energy to the furnace, supplies ionized gas to the molten metal oxide and/or molten metal, and/or reduces the molten metal oxide. In some embodiments, the roof comprises multiple electrodes that extend from the roof towards the hearth of the furnace, wherein the furnace is configured to generate an electric arc between a distal end of each electrode of the multiple electrodes and the at least one opposite electrode. In some embodiments, a distance between the multiple electrodes is such that there is not any arc interference between the electric arc of each electrode and the at least one opposite electrode. In some embodiments, a distance between the multiple electrodes is such that there is arc interference between the electric arc of each electrode and the at least one opposite electrode, such that the arcs merge towards the center of the molten metal oxide. In some embodiments, the at least one electrode and/or at least one opposite electrode comprises graphite, titanium, tungsten, tantalum, zirconium, or copper. In some embodiments, the electric arc agitates the molten metal oxide. In some embodiments, the plurality of feed ports are configured such that feed ports closer to a center of the roof introduce more molten metal oxide to the furnace than feed ports further from the center of the roof. In some embodiments, the applicability of the molten metal oxide to the method is dictated by the thermodynamic potential for reduction by the injected fluid and/or ionized fluid, such as iron oxides, chrome oxides, nickel oxides, copper oxides, and phosphorous oxides in the embodiments in which ionized hydrogen and/or molecular hydrogen are present. In some embodiments, the molten metal oxide comprises iron oxide, hematite, magnetite, or combinations thereof. In some embodiments, the molten metal comprises metallic iron. In some embodiments, the shell or plurality of walls comprises at least one heat exchanger. In some embodiments, the at least one heat exchanger comprises water cooling. In some embodiments, the shell or plurality of walls comprises water-cooled copper. In some embodiments, an interior of the shell or plurality of walls comprises a castable refractory lining or state-of-the art technology for enhancing furnace integrity. In some embodiments, the plurality of injectors is configured to inject a fluxing source or metal oxide into the furnace. In some embodiments, the fluid is injected in combination with a solid such as fluxes or fine metal oxide, wherein the flux or injected metal oxide serves as bubble nucleation points for the injected gas to increase the surface area of a reaction between the fluid and the metal oxide in the slag layer. In some embodiments, the plurality of injectors is configured to inject a carbon source into the furnace. In some embodiments, the carbon source is a solid carbon source. In some embodiments, the solid carbon source is injected into the metal bath for carburization. In some embodiments, carburization of the molten metal is performed in a downstream ladle metallurgy process.

In some embodiments, a method includes introducing a molten metal oxide into a furnace through a plurality of feed ports in a roof and/or side of the furnace; maintaining the molten metal oxide in the furnace in its molten state; and introducing a fluid into the furnace through a plurality of injectors in a side of the furnace, wherein the fluid reduces the molten metal oxide to molten metal. In some embodiments, the fluid is introduced in a direction towards the molten metal oxide in the furnace. In some embodiments, the fluid is introduced towards an adjacent injector. In some embodiments, the fluid is introduced into the molten metal oxide. In some embodiments, the fluid is introduced into the molten metal, wherein the molten metal has a lower viscosity than the molten metal oxide and therefore results in decreased bubble diameter formed from the injected fluid. In some embodiments, the fluid is introduced at an angle less than 90 degrees with respect to a line that is tangent to each injector of a cross section of the shell or plurality of walls perpendicular to an internal axis. In some embodiments, the fluid is introduced such that the fluid agitates the molten metal oxide in the furnace to create a homogenous slag composition and enhance separation of metallics contained in the slag such that the metallics collect in a metal layer below the slag layer. In some embodiments, the fluid is introduced such that the molten metal oxide swirls within the furnace. In some embodiments, the plurality of injectors is spaced equidistant around a circumference of the shell or plurality of walls. In some embodiments, the fluid comprises hydrogen and/or carbon. In some embodiments, the method includes generating an electric arc between a distal end of at least one electrode that extends from the roof of the furnace towards the bottom of the furnace and at least one opposite electrode at the bottom of the furnace, wherein the electric arc is configured to provide thermal energy to the bath. In some embodiments, the electric arc is between the distal end of the at least one electrode and the molten metal oxide and/or molten metal of the furnace. In some embodiments, the method includes introducing the fluid into the furnace through a port running through a central axis of the at least one electrode. In some embodiments, the method includes generating a plasma from the introduced fluid and the electric arc. In some embodiments, the electric arc agitates the molten metal oxide and/or molten metal. In some embodiments, the method includes introducing more molten metal oxide into the furnace through feed ports closer to a center of the roof than feed ports further from the center of the roof. In some embodiments, the molten metal oxide comprises iron ore. In some embodiments, the molten metal oxide comprises iron oxide, hematite, magnetite, iron oxide-containing waste streams, or combinations thereof. In some embodiments, the molten metal comprises metallic iron. In some embodiments, the method includes introducing a carbon source into the furnace through the plurality of feed ports and/or through the plurality of injectors. In some embodiments, the carbon source is a solid carbon source, used to carburize the metallic iron. In some embodiments, any fluid injected into the slag layer partially escapes without reducing the molten metal oxide. In some embodiments, the fluid that escapes from the molten metal oxide generates a plasma around the electric arc. In some embodiments, ionized fluid around the electric arc is sucked into the molten metal oxide by arc momentum. In some embodiments, the ionized fluid reduces the molten metal oxide near the arc. In some embodiments, the ionized fluid around the electric arc becomes un-ionized, exothermically contributing to heat generation in the furnace. In some embodiments, the furnace is a DC or AC electric arc furnace. In some embodiments, the method operates in a batch, continuous, or semi-continuous mode.

It will be appreciated that any of the variations, aspects, features and options described in view of the furnace apply equally to the systems, methods, other furnaces, and vice versa. It will also be clear that any one or more of the above variations, aspects, features and options can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

The invention will now be described, by way of example only, with reference to the accompanying drawings, in which:

FIG. 1 illustrates an exemplary steelmaking process in accordance with some embodiments herein.

FIG. 2 illustrates another exemplary steelmaking process in accordance with some embodiments herein.

FIG. 3 illustrates an example of a cross section of half of a furnace in accordance with some embodiments herein.

FIG. 4 illustrates fluid flow in an example of a cross section of half of a furnace in accordance with some embodiments herein.

FIG. 5 illustrates radial fluid injection from the top view of a furnace in accordance with some embodiments herein.

FIG. 6 illustrates angled fluid injection from a top view of a furnace in accordance with some embodiments herein.

FIG. 7A illustrates a top view of exemplary zones of metal oxide feed in accordance with some embodiments herein.

FIG. 7B illustrates a cross section of exemplary zones of metal oxide feed, metallic layer, slag layer and feed build-up in accordance with some embodiments herein.

FIG. 8A illustrates a view of components of a slag layer in accordance with some embodiments herein.

FIG. 8B illustrates a magnified view of components of a slag layer in accordance with some embodiments herein.

FIG. 9A illustrates a portion of a cross section of an exemplary shell of a furnace in accordance with some embodiments herein.

FIG. 9B illustrates a larger portion of a cross section of an exemplary furnace with shell in accordance with some embodiments herein.

FIG. 10A illustrates a top view of an exemplary furnace design in accordance with some embodiments herein.

FIG. 10B illustrates a cross section of an exemplary furnace design in accordance with some embodiments herein.

FIG. 11 illustrates an exemplary layout of electrodes from the perspective of the roof of a furnace in accordance with some embodiments herein.

FIG. 12A illustrates an exemplary hydrogen utilization flowchart in accordance with some embodiments herein.

FIG. 12B illustrates an exemplary hydrogen utilization chart with respect to the weight percentage of FeO in the slag, in accordance with some embodiments herein.

FIG. 12C illustrates an exemplary hydrogen flowrate chart with respect to the weight percentage of FeO in the slag, in accordance with some embodiments herein.

FIG. 12D illustrates another exemplary hydrogen flowrate chart in accordance with some embodiments herein.

FIG. 13A illustrates another exemplary steelmaking process in accordance with some embodiments herein.

FIG. 13B illustrates another exemplary steelmaking process in accordance with some embodiments herein.

FIG. 13C illustrates another exemplary steelmaking process in accordance with some embodiments herein.

In the Figures, like reference numbers refer to like components unless stated herein to the contrary.

### DETAILED DESCRIPTION

Reference will now be made in detail to implementations and embodiments of various aspects and variations of furnaces, systems, and methods described herein. Although several exemplary variations of furnaces, systems, and methods are described herein, other variations of the furnaces, systems and methods can include aspects of the furnaces, systems and methods described herein combined in any suitable manner having combinations of all or some of the aspects described. For example, variations of the system and methods can be applied to convert a molten metal-oxide containing feed or slag into a refined metal.

The BF-BOF process of producing steel is a four-step, energy-intensive process. The process can involve converting coal into coke through a coking plant, sintering or pelletizing fine or lump iron ore in a separate step, reducing the iron ore to carburized metallic iron in a blast furnace, and removing excess carbon and/or adding scrap metal in the basic oxygen furnace. The blast furnace is the most energy-intensive step because it involves using coke to heat the iron oxide to temperatures above the melting point of iron and using coke as a reductant to convert iron oxide to metallic iron. Alternative processes, such as the direct reduction of iron (DRI) in an electric arc furnace (EAF), use natural gas and/or hydrogen as a reducing gas, which can significantly reduce carbon emissions compared to blast furnaces. However, DRI-EAF is a three-to four-step process in which high-grade iron ore is first pelletized, the iron ore is reduced in the DRI process, and the reduced iron is melted in an EAF or the reduced iron is melted in a submerged arc furnace and purified prior to refining in an EAF. The DRI process, when solely using hydrogen, may require additional heat input due to the overall endothermic nature of the molecular hydrogen reaction. Currently, 5% of the hydrogen gas mixture can consist of natural gas or other carbon-containing gases to offset the energy demand of the endothermic reaction in the DRI process. Additionally, because the EAF has historically relied on carbon being included in the iron (called pig iron), DRI-EAF still may require carbon input to maintain the temperature of the downstream EAF through the carbon-oxygen exothermic reaction. The hydrogen plasma smelting reduction (HPSR) reaction and/or molecular hydrogen reduction reaction can improve over both processes by harnessing the ionized state of hydrogen to reduce iron ore and contribute to heat generation. Hydrogen ions have greater reduction potential and can reduce iron ore into molten iron and steel in a single step. HPSR can also be an overall exothermic reaction, and the thermal energy produced through ionizing the gas can be harnessed and recycled. Thus, HPSR and/or molecular hydrogen reduction reactions can lower capital costs, operation costs, and carbon emissions compared to BF-BOF and DRI-EAF processes. In combination with the methods of reducing the iron oxide in the slag layer with molecular hydrogen disclosed herein, the HPSR and/or molecular hydrogen reduction process can be scalable and economically viable.

Disclosed herein are systems, methods, and furnaces for molten metal production. The furnace described herein is capable of running HPSR reactions and/or molecular hydrogen reduction reactions. The furnace described herein can improve the reduction kinetics and overall hydrogen utilization in HPSR and/or molecular hydrogen reduction, compared to the state-of-the-art HPSR systems and compared to hydrogen DRI processes, through various modes of hydrogen injection. The modes of hydrogen injection in the furnace described herein can improve the surface area on which to run the HPSR reaction and/or molecular hydrogen reduction reaction. The systems, methods, and furnace described herein can recycle thermal energy and off-gases for improved energy efficiency and reduced operating costs. In addition, the systems, methods, and furnace components described herein can be compatible with commercial steelmaking furnaces to accelerate technology adoption.

Disclosed herein is a furnace that can be used for molten metal production. The furnace can have walls (e.g., side walls) and/or a shell(s), which can have a top portion and a bottom portion. The top portion may include a roof, and the bottom portion may include a hearth, with walls, shell(s), or combination thereof to connect the roof and hearth. The shell or walls can include a plurality of injectors. In some embodiments, the injectors can be configured to inject a fluid into the furnace. In some embodiments, the fluid may be molecular hydrogen. In some embodiments, the furnace can be used to conduct HPSR and/or molecular hydrogen reduction reactions, in which case the hydrogen (e.g., the molecular hydrogen) can be heated. The furnace can supply the energy to the hydrogen so that it ionizes in order to serve as a reducing agent. In some embodiments, the injectors may inject the hydrogen without pre-heating it, in which case an electrode inside the furnace can heat the hydrogen and if needed, melt the feed or maintain the feed in a molten state. In some embodiments, the injectors may pre-heat the hydrogen so that the furnace can primarily heat iron ore or a metal oxide instead, which can reduce the thermal load on the furnace and can improve energy efficiency.

In some embodiments, there may be at least one electrode attached to the roof of the furnace. The roof may also have a plurality of feed ports where iron ore or a metal oxide can be fed into the furnace. The electrode may be used to heat a reducing gas or melt iron ore or metal oxide that is fed into the furnace. In some embodiments, there may be an opposite electrode attached to the hearth of the furnace. In some embodiments, the electrodes are used to strike an arc between the electrode and feed or opposite electrode. In some embodiments, the temperatures surrounding the electric arc can be greater than 3,000 degrees Celsius. In some embodiments, the electrodes are submerged, in which case ionized hydrogen does not form. Rather, the injected molecular hydrogen can perform the reduction reaction. In some embodiments, there may be multiple electrodes attached to the roof within a distance of one another such that the formed arcs merge towards the center of the roof. In some embodiments, the distance between the electrodes is such that the arcs behave independently of one another.

In some embodiments, the hearth may hold a molten bath. The molten bath may include a layer of slag, which may contain molten metal oxide, and a metal layer which may contain molten metal. In some embodiments, HPSR and/or molecular hydrogen reduction reactions can take place in the layer of slag. In some embodiments, the layer of slag may be foamy. In some embodiments, the slag may sit on top of the metal layer, and metal may sink toward the bottom of the hearth as the metal oxide in the slag is reduced to molten metal. In some embodiments, the metal oxide is banked around the arc, and the HPSR and/or molecular hydrogen reduction reaction takes place in the banked metal oxide sitting above the slag or molten bath.

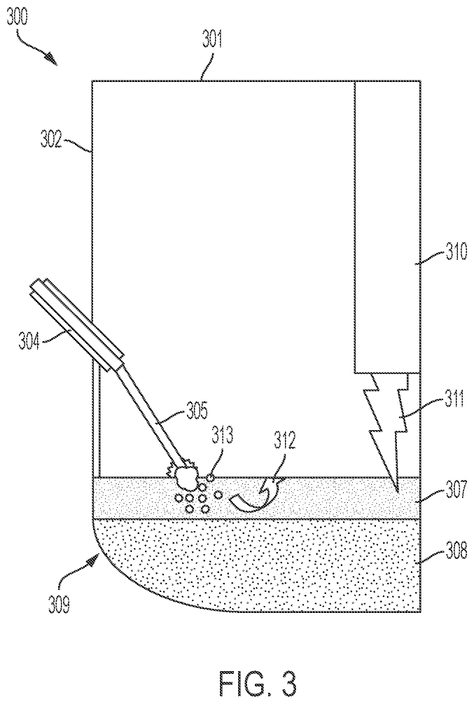

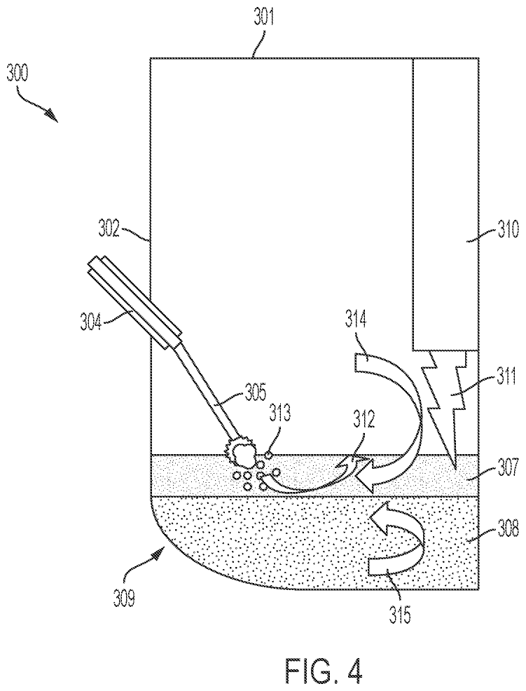

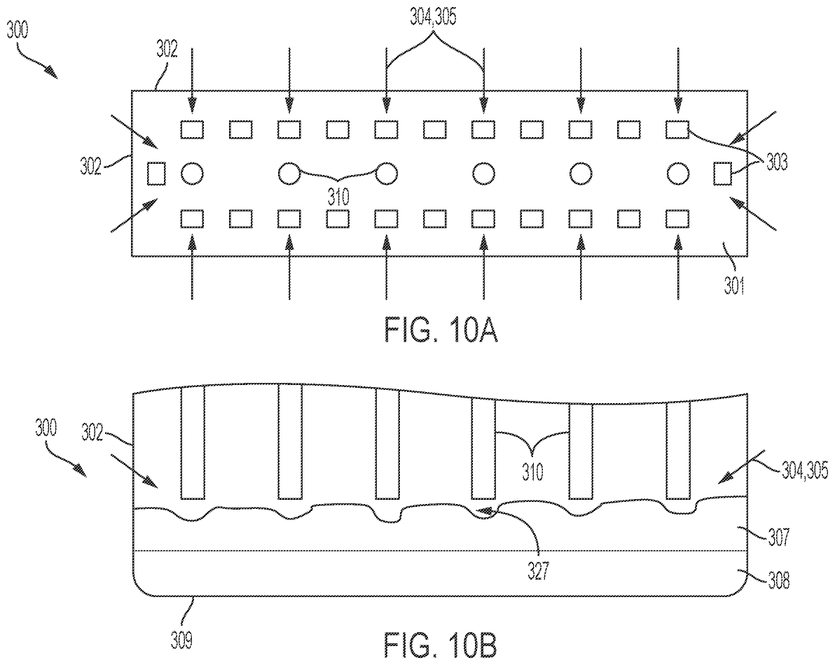

In some embodiments, the furnace can be configured to melt metal oxide that enters the furnace to form a molten bath. In some embodiments, the furnace can be configured to receive the molten bath (including both slag and metal layers) and keep it in its molten state. In some embodiments, the furnace can be configured to melt the metal oxide, keep the metal layer and slag layer in the molten phase, supply thermal energy to the furnace, supply ionized gas to the bath, and/or reduce the metal oxide. FIG. 3 illustrates an example of a cross section of half of a furnace 300 disclosed herein. In some embodiments, the furnace can come in a wide variety of shapes and sizes. For example, the furnace can be spherical, cylindrical, square, rectangular, etc. For example, FIGS. 3-4 illustrate a furnace that is cylindrical in shape, whereas FIGS. 10A and 10B illustrates a furnace that is rectangular in shape. In some embodiments, the furnace can have a diameter D that is about 1-100 meters, about 1-50 meters, about 1-25 meters, about 5-25 meters, about 10-20 meters, or about 15 meters.

In some embodiments, the furnace can include a roof or top 301. The roof can be configured to introduce a material such as a metal oxide into the furnace for melting. In some embodiments, the metal oxide can be any component used to make steel. In some embodiments, the metal oxide is iron ore. In some embodiments, the iron ore can be in the form of fines, lumps, and/or pellets. In some embodiments, the metal oxide can include iron oxide, hematite, magnetite, iron oxide-containing waste streams, or combinations thereof. Examples of iron oxide-containing waste streams can be waste generated from mineral sands processing, waste generated when converting ilmunite to synthetic rutile via Becher process, among others. In some embodiments, the metal oxide can be pre-reduced metal oxide. In some embodiments, an off-gas from the furnace may partially consist of the reducing gas and can be used to pre-reduce the metal oxide. An off-gas can be created by all the gases in the furnace including the hydrogen that hasn't reacted with the materials in the furnace, the water vapor due to the hydrogen that has reacted with oxygen in the furnace, and the gangue elements that have vaporized due to the high temperatures in the furnace (e.g. sulfur and phosphorous). In some embodiments, the pre-reduction of the metal oxide can take place in a separate furnace. In some embodiments, the off-gas can be processed to remove water vapor and/or vaporized gangue elements such that mostly hydrogen remains. The hydrogen can be re-injected into the furnace. In some embodiments, the off-gas can be processed to remove vaporized gangue elements and reduce the temperature. This reduced and processed off-gas can be sent to a solid water to a low-temperature or high-temperature water electrolyzer to re-generate the fluid (e.g., hydrogen gas).

In some embodiments, the feed ports can be configured to introduce a carbon source into the furnace. In some embodiments, the carbon source can be a solid carbon source such as biochar, coal, graphite, methane, natural gas and/or carbon black. In some embodiments, the solids whether introduced through the feed ports or injected through an injector(s) (described below) into the furnace can serve a nucleation points for bubble nucleation. In some embodiments, the carbon source is injected into the metal bath for carburization of the molten metal. In some embodiments, the carbon source can be a gas and introduced through fluid injectors. In some embodiments, the gaseous carbon source can be natural gas/methane.

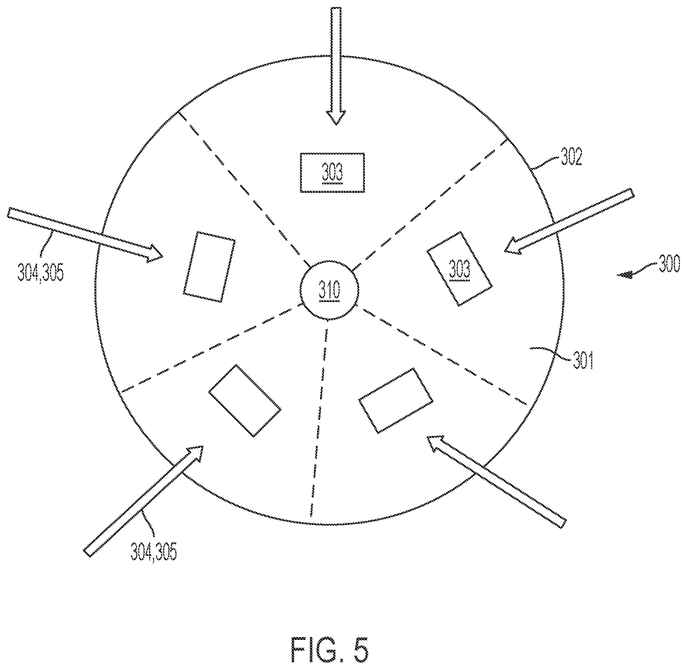

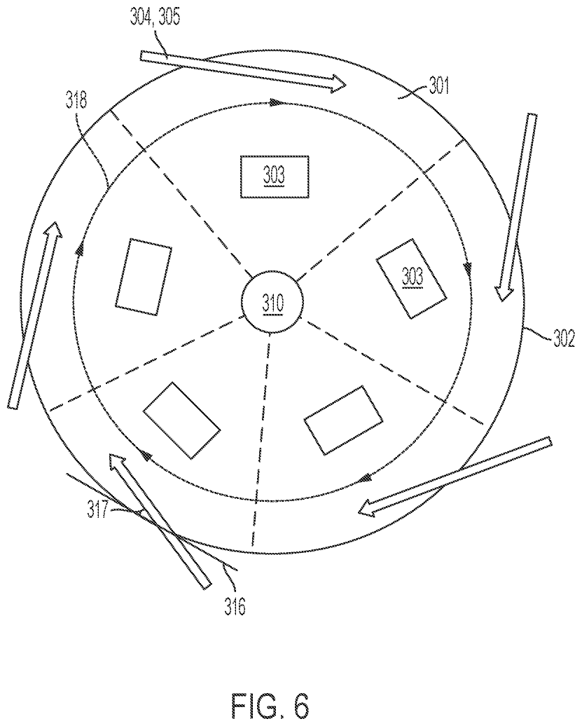

In some embodiments, the roof can include a plurality of feed ports 303. The feed ports (bins or hoppers) can be configured to introduce the metal oxide into the furnace for subsequent melting. In some embodiments, the plurality of feed ports can be arranged in a circular or annular fashion around the roof of the furnace as shown in FIGS. 5-6. In some embodiments, the plurality of feed ports can be arranged in a circular or annular fashion around the center of the roof. In some embodiments, the plurality of feed ports can be arranged around the perimeter of the roof as shown in FIGS. 10A and 10B. In some embodiments, the each feed port of the plurality of feed ports can be equidistant from one another. In some embodiments, the number of feed ports can be determined according to the fluid injection area of influence described below.

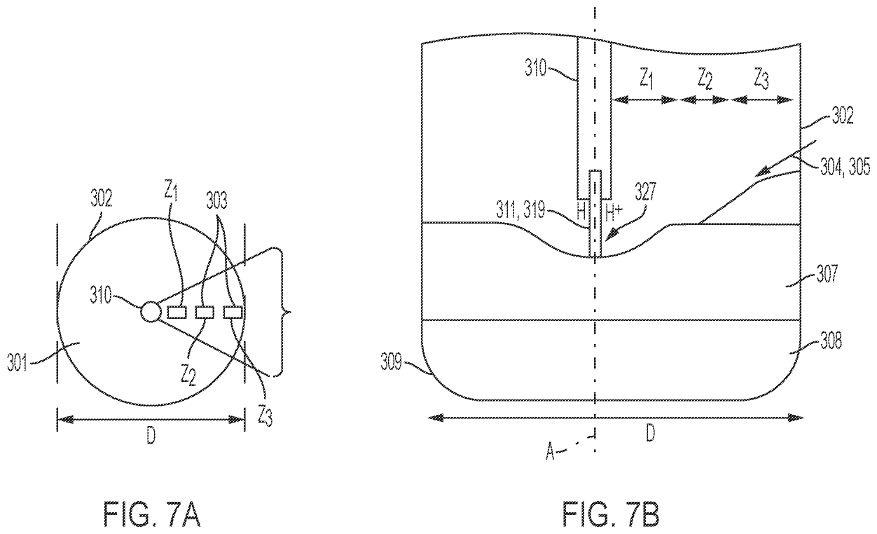

In some embodiments, the plurality of feed ports can be configured such that feed ports closer to a center of the roof can introduce more metal oxide to the furnace than feed ports further from the center of the roof. For example, FIGS. 7A and 7B illustrate an example of zoning the feed ports from the perspective of a cross section or half of a cross section of a cylindrical furnace. In some embodiments, the feed ports can be arranged in at least one zone that is in a circular or annular fashion around the center of the roof. In some embodiments, the zone(s) closer to the center of the roof can introduce more feed material (e.g., metal oxide) than an adjacent zone farther from the center of the roof. These feed port zones can be arranged in an annular fashion around the center of the roof. For example, FIGS. 7A and 7B illustrate feed port zones Z₁, Z₂, and Z₃. Z₁, which is closer to the center (electrode 310) of the roof than Z₂ and Z₃, can introduce more feed material than Z₂ and Z₃. For example, the feed ports of Z₁ which are closer to the center of the roof can introduce 60% of the total feed, the feed ports of Z₂ which is further from the center of the roof than Z₁ can introduce 30% of the total feed, and the feed ports of Z₃ which is further from the center than Z₂ can introduce 10% of the total feed. As such, the feed port zones that are farther from the center of the roof can introduce a lower percent of the total feed than those ports that are closer to the center of the roof. In some embodiments, the opposite can be true (i.e., the feed port zones that are farther from the center of the roof can introduce a greater percent of the total feed than those ports that are closer to the center of the roof). Additionally, gas injectors can be placed through roof ports, such as Top-Submerged-Lances.

In some embodiments, a molten metal can be formed by introducing a metal oxide into a furnace through a plurality of feed ports in a roof of the furnace. For example, the furnace can be configured to melt the metal oxide feed to form a molten bath. In some embodiments, the molten bath can include at least a slag layer 307 and a metal layer 308. In some embodiments, the slag layer can include slag. In some embodiments, the slag layer can include molten metal oxide. In some embodiments, the slag layer can be a by-product of melting the feed material (e.g., iron ores). In some embodiments, the slag layer can include ferrous materials, ferroalloys, and/or non-ferrous/base metals (e.g., copper, nickel, zinc, phosphorous, etc.). In some embodiments, the slag layer can include a fluid that can reduce the molten metal oxide. In some embodiments, the metal layer can include molten metal. In some embodiments, the slag layer can be a by-product produced during the separation of the molten metal from impurities in the molten metal making process. In some embodiments, the molten metal can include metallic iron that can be used for steel. In some embodiments, only a slag layer exists without the separation of a metallic from the slag layer.

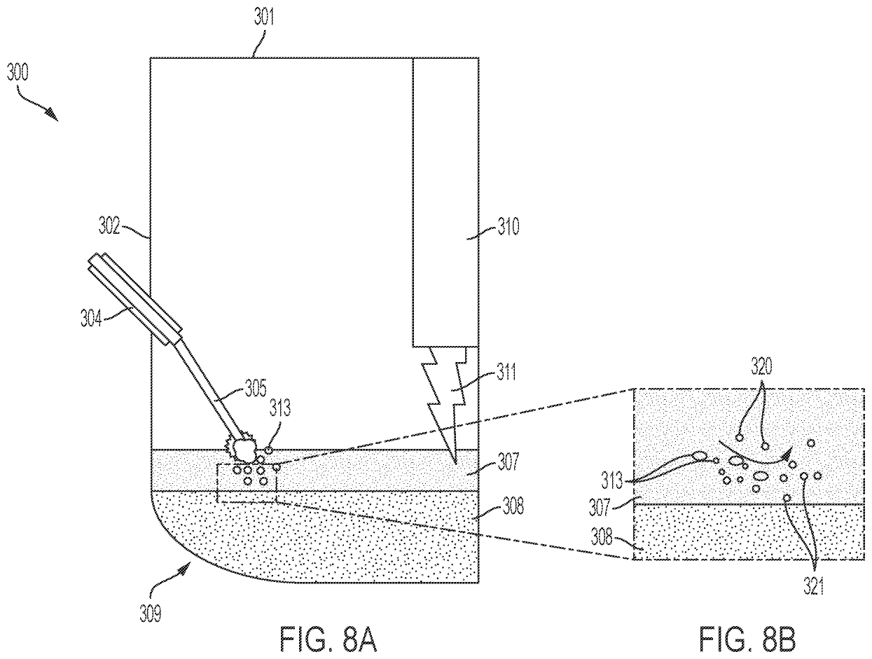

In some embodiments, the components in the slag layer (e.g., the molten metal oxide) can be reduced to form the molten metal in the metal layer. The metal layer can have a density that is greater than the slag layer such that the metal layer will settle to the bottom of the furnace with the slag layer above it. For example, FIG. 8B illustrates a fluid or fluid bubbles 313 (e.g., hydrogen gas) in the slag layer 307 reducing metal oxide (e.g., iron oxide) 320 in the slag layer to form the metal 321 (e.g., metallic iron) that has a greater density than the metal oxide and sinks or settles towards the bottom of the furnace. Depending on the density and viscosity of the slag layer, agitation in the slag layer and bath mixing, a portion of the metal may remain as droplets within the slag layer. Above the slag layer can be unreacted fluid (as described below), product gases (e.g., water vapor), and/or vaporized gangue elements (e.g. sulfur and/or phosphorous) from the reduction process.

In some embodiments, the furnace can include a shell, wall, or plurality of walls (e.g., sidewalls) 302. The shell can act as a sidewall(s) or wall(s) of the furnace. In some embodiments, the shell can comprise a plurality of walls. In some embodiments, the shell can be cylindrical, square, rectangular, spherical, etc. in shape. In some embodiments, the shell can include a top portion and a bottom portion. In some embodiments, the roof can be connected to the top portion of the shell to enclose the top of the furnace/shell. In some embodiments, the roof and shell can be integrally connected/combined so as to form a single unit. In some embodiments, the furnace can include a hearth 309 towards the bottom of the furnace. In some embodiments, the hearth can be connected to the bottom portion of the shell to enclose the bottom of the furnace/shell. In some embodiments, the hearth and shell can be integrally connected/combined so as to form a single unit. In some embodiments, the roof, shell, and hearth can be integrally connected/combined so as to form a single unit. In some embodiments, the walls or shell(s) of the furnace can include feed ports.

In some embodiments, the shell can include a plurality of injectors 304 configured to inject a fluid 305 into the furnace. The fluid injected into the furnace can reduce the feed material (e.g., metal oxide) and/or material in the slag layer (e.g., molten metal oxide). The injectors can be configured to inject a fluid into the furnace such that there is enough residence time with the metal oxide in the slag layer to reduce it to the metal. In some embodiments, the fluid can reduce the molten metal oxide in the slag layer to molten metal that can settle in the metal layer below the slag layer. In some embodiments, the fluid can reduce the metal oxide to metal (e.g., metallic iron) prior to melting. In some embodiments, the fluid can also reduce ilmunite, copper oxide, and/or any other metal oxides or ores in the furnace or slag layer. In some embodiments, the fluid can be a reducing gas. In some embodiments, the reducing gas is hydrogen gas (e.g., molecular hydrogen), atomic hydrogen, ionized hydrogen, methane, natural gas, ammonia, and/or any other hydrogen-containing fluids or gases.

In some embodiments, at least one of the plurality of injectors is configured to inject fluid into the furnace such that the fluid can agitate the molten bath, slag layer, and/or metal layer in the furnace. In some embodiments, the fluid can be introduced into the furnace such that it agitates the molten bath to create a homogenous slag composition and/or enhance separation of the molten metal contained in the slag such that the molten metal can collect/settle to the metal layer below the slag layer. In some embodiments, at least one of the plurality of injectors can be configured to inject fluid into the furnace such that the fluid induces mixing of the slag layer and/or metal layer of the molten bath. Such mixing and/or agitation 312 can increase the gas-solid and/or gas-liquid reduction reaction rates in the furnace. In some embodiments, the plurality of injectors can be configured to inject fluid such that the fluid can penetrate the molten bath (e.g., slag and/or metal layer).

In some embodiments, at least one of the plurality of injectors is configured to inject the fluid radially inward into the furnace such as shown in FIG. 5. In some embodiments, at least one of the plurality of injectors is configured to inject the fluid towards the hearth of the furnace such as shown in FIGS. 3-4. In some embodiments, at least one of the plurality of injectors is configured to inject the fluid towards the molten bath in the furnace. In some embodiments, at least one of the plurality of injectors is configured to inject fluid towards a working area of the furnace. In some embodiments, the working area can be where the molten bath and/or slag layer (e.g., molten metal oxide) is in the furnace. In some embodiments, at least one of the plurality of injectors can be configured to inject fluid into the molten bath of the furnace. In some embodiments, at least one of the plurality of injectors can be configured to inject fluid into the slag layer and/or metal layer of the molten bath in the furnace. In some embodiments, the injectors can be submerged in the molten bath. In some embodiments, the injectors can be located above the molten bath.

In some embodiments, fluid injection into the molten bath (e.g., slag layer and/or metal layer) can result in fluid flow according to buoyancy effects (fluid density can be less than molten bath density, slag density, or metal density) and transfer of momentum from the injected fluid to the molten bath. In some embodiments, the momentum transfer of injected fluid to the molten bath can also occur as the injected fluid can break up into bubbles 313 in the molten bath. As such, buoyancy forces and/or mixing from the injected fluid can increase the reduction reaction rates in the furnace. In some embodiments, the fluid injected into the furnace can shear within the molten bath (e.g., slag layer and/or metal layer) to produce discrete volumes of gas which can be bubbles 313. In some embodiments, at least some of the bubbles 313 can be spherical. In some embodiments, at least some of the bubbles 313 may not be spherical. The amount, volume, and shape of the discrete volumes of gas can vary based on the angle and direction of the shear caused by the fluid injectors.

In some embodiments, at least one of the plurality of injectors can be configured to inject a fluid towards and/or into a first area of the molten bath (e.g., slag layer). In some embodiments, at least one of the plurality of injectors can be configured to inject a fluid towards and/or into a second area of the molten bath different from the first area of the molten bath such that the fluid can reach/interact with different areas of the molten bath. In some embodiments, each injector of the plurality of injectors is configured to inject the fluid towards and/or into a different area of the molten bath.

In some embodiments, at least one of the plurality of injectors can be configured to inject fluid in a direction toward an adjacent injector. In some embodiments, the plurality of injectors can be configured to inject fluid such that the slag layer and/or metal layer of the molten bath swirls within the furnace to increase mixing and/or agitation of the molten bath with the fluid (and thereby increase reduction reaction rates). In some embodiments, the shell of the furnace can have an internal axis A shown in FIG. 7B longitudinally running through the center of the shell (and furnace). In some embodiments, at least some of the plurality of injectors can be configured to inject fluid at an angle less than 90 degrees with respect to a line that is tangent to each injector of a cross section of the shell perpendicular to the internal axis. For example, FIG. 6 illustrates a cross section of the shell perpendicular to the internal axis. In FIG. 6, the injectors are configured to inject fluid at an angle 317 less than 90 degrees (e.g., 10-45 degrees, 10-30 degrees, 20-30degrees, or 20-25 degrees) with respect to line 316 that is tangent to each injector 304 of the cross section. Angling such injectors can create a swirling effect 318 of the molten bath (e.g., slag layer and/or metal layer). In some embodiments, the plurality of injectors can be spaced equidistantly around a circumference of the shell. In some embodiments, the plurality of injectors can be spaced equidistantly around a perimeter of the shell.

In some embodiments, at least one of the plurality of injectors can be submerged in the molten bath. In some embodiments, at least one of the plurality of injectors can be submerged in the slag layer and/or metal layer of the molten bath. In some embodiments, at least one of the plurality of injectors can be submerged in the molten bath between the slag and metal layers. In some embodiments, the submerged injector(s) can be in contact with both the slag and metal layers of the molten bath. In some embodiments, the plurality of injectors can include injectors that are submerged in the molten bath and injectors that are not submerged (e.g., above the molten bath).

In some embodiments, the roof can also include at least one injector configured to inject fluid into the furnace. In some embodiments, the roof can include a plurality of injectors configured to vertically inject fluid into the furnace. In some embodiments, the plurality of injectors in the roof can be configured to inject fluid at a 90 degree angle with respect to the roof such that it is perpendicular to the molten bath (e.g., slag layer of the molten bath).

In some embodiments, the plurality of injectors disclosed herein can include lances, supersonic jets, coherent jets, plasma torches or jets, injectors configured to inject both gases and solids, or combinations thereof. In some embodiments, the plasma torches may be non-thermal plasma torches. In some embodiments, the coherent jets can include supersonic coherent jets, subsonic coherent jets, and/or coherent jets with shrouded flames. In some embodiments, the fluid can be preheated prior to being injected into the furnace such that the thermal energy in the furnace is not wasted on heating the fluid. In some embodiments, plasma torches can electrically heat the fluid prior to injecting into the furnace such that the fluid can either contribute to the thermal energy supplied to the furnace and/or molten bath (if it's hotter than the molten bath) or if it's the same temperature of the bath, any energy of the furnace may not be wasted on heating the fluid.

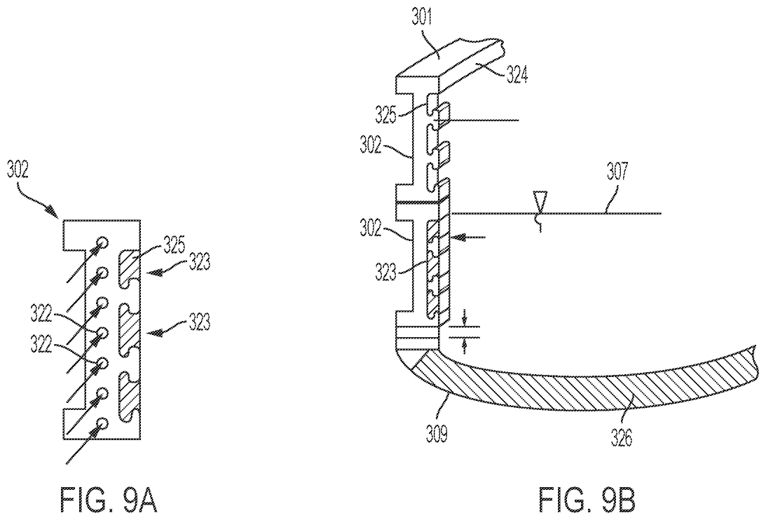

In some embodiments, the shell can include at least one heat exchanger 322. In some embodiments, the at least one heat exchanger can be used to protect the shell itself from melting due to the heat utilized in the furnace. In some embodiments, the shell can include a plurality of heat exchangers to cool the shell. In some embodiments, the at least one heat exchanger can be a heat exchanger that utilizes water cooling through the interior of the shell. In some embodiments, the shell can be formed from multiple shell segments as shown in FIG. 9B. In some embodiments, the interior of the shell can include a plurality of notches, spaces, or openings 325 where slag can solidify 323, thereby forming a protective layer on the interior of the shell. In some embodiments, the shell can be made out of copper. In some embodiments, the shell can include at least one copper cooler. In some embodiments, the roof can also be made out of copper and/or can include at least one copper cooler. The copper cooler can have at least one heat exchanger (e.g., water cooling) in the walls of the cooler. In some embodiments, the interior of the furnace (e.g., the shell, roof, and/or hearth) can be lined with a castable refractory lining 324. Arc radiation and radiation from the molten pool can require resistant materials to line the furnace wall. The purpose of the refractory lining can be to enhance furnace integrity by protecting the walls from the splashing of the molten metal and slag, intense heat within the furnace, and/or radiation. Additionally, the lining reduces heat loss from the furnace to the surrounding environment. Any state-of-the art technology for enhancing furnace integrity may be applied in some embodiments.

In some embodiments, the plurality of feed ports and/or the plurality of injectors can be configured to introduce a carbon source into the furnace. In some embodiments, the carbon source is a solid carbon source, such as waste plastics, coal, coke or biochar. In some embodiments, carbon can be injected into the furnace and molten bath such that the desired amount of carbon can be present in the molten bath to form the desired product (e.g., 2% carbon in iron for steel production). In some embodiments, reduction of a metal oxide may take place without the addition of carbon. In some embodiments, the solids injected through an injector(s) (described below) into the furnace can serve a nucleation points for bubble nucleation. In some embodiments, the solids can be injected simultaneously and/or in combination with the fluid either in the same or different injectors. The solids can serve as bubble nucleation points for the injected fluid to increase the surface area of the reaction between the fluid and the feed materials (e.g., metal oxide).

In some embodiments, the furnace can include at least one heating source. In some embodiments, the roof can include at least one electrode 310 (e.g., a cathode) that extends from the roof towards the hearth of the furnace. In some embodiments, the hearth can include at least one opposite electrode 326 (e.g., an anode) from the at least one electrode. In some embodiments, the at least one opposite electrode can be embedded within the hearth of the furnace. The furnace can be configured to generate an electric arc 311 between a distal end of the at least one electrode and the at least one opposite electrode. In some embodiments, the at least one electrode is a cathode and the at least one opposite electrode is an anode at any given time, under either alternating current or direct current electrical operation. This electric arc can be configured to melt the feed material (e.g., the metal oxide) to form the molten bath. In some embodiments, the at least one electrode can be centered in the furnace. In other words, the at least one electrode can be on the interior axis A of the furnace.

In some embodiments, the electric arc can be between a distal end of the at least one electrode and the molten bath of the furnace. In some embodiments, the distal end of the at least one electrode can be above the molten bath or slag layer of the molten bath. In some embodiments, the distal end of the at least one electrode can be submerged in the molten bath (e.g., in the slag layer and/or metal layer). In some embodiments, the electric arc can be a transferred or non-transferred electric arc. In embodiments in which a transferred arc is employed, the molten bath can be part of the electrical circuit. The electric arc can be constituted between the electrode and the molten bath, which may not be in direct physical contact with one another. Ionized gas can be generated in and around the electric arc and may come into contact with the molten bath. In embodiments in which a non-transferred electric arc is employed, the electric arc may not interact with the molten bath. Instead, a plasma torch, for example, may be used in which the electric arc can be generated between an electrode and the nozzle of the plasma torch. Ionized gas can be produced within the plasma torch and hot gas exits to the torch at high temperature and high velocities. The transferred arc configuration can have ˜20% greater electro-thermal efficiency than a non-transferred arc technology.

In some embodiments, the electric arc can contribute the flow patterns in the molten bath (e.g., slag layer and/or metal layer). In some embodiments, momentum 314 of the electric arc can force a portion of the molten bath (e.g., a portion of the slag layer and/or metal layer) away from the electric arc to form a concave dent 327 in the molten layer (e.g., in the slag layer and/or metal layer) as shown in FIGS. 7B and 10B. In some embodiments, the fluid and materials (e.g., metal oxide) surrounding the electric arc can be pulled in towards the electric arc. In some embodiments, the flow pattern due to the electric arc can be a counter flow to the buoyancy effects of the fluid injected into the molten bath. As such, both the electric arc and fluid injection can contribute to the agitation/mixing of the molten bath to increase the reaction rates for reduction of the materials in the molten bath. In some embodiments, there can be a flow pattern 315 in the metal layer due to shear forces between the metal layer and the slag layer.

In some embodiments, the at least one electrode can be hollow. As such, the at least one electrode can include a port running through a central axis of the at least one electrode. In some embodiments, the port can be used to inject fluid and/or feed materials. In some embodiments, the at least one electrode can be solid (i.e., not hollow). In such embodiments, the fluid can be injected solely through the plurality of injectors in the shell and/or roof, but not through the at least one electrode.

In some embodiments, at least a portion of the fluid injected into the furnace can pass through the electric arc to form a plasma. In some embodiments, fluid can be injected into the molten bath and some of that fluid may escape the molten bath without reducing the metal oxide in the slag layer. In some embodiments, the fluid that escapes the molten bath can generate plasma around the electric arc. In some embodiments, the plasma can form around the electric arc. In some embodiments, the plasma can surround the electric arc. The fluid that passes through the electric arc can become an ionized fluid. For example, hydrogen gas passing through the electric arc can become ionized hydrogen. In some embodiments, the ionized fluid and/or plasma can exist around the electric arc and/or be pulled into the molten bath. In some embodiments, the plasma can melt the feed material (e.g., metal oxide) and/or can supply thermal energy to the furnace. In some embodiments, the plasma can also reduce the feed material (e.g., metal oxide) or molten feed material (e.g., molten metal oxide). In some embodiments, the ionized fluid around the electric arc can get sucked into the molten bath (e.g., slag layer and/or metal layer) due to arc momentum. In some embodiments, the ionized fluid can reduce the metal oxide in the slag layer near the electric arc. In some embodiments, the ionized fluid can become un-ionized which can exothermically contribute to heat generation in the furnace. For example, ionized hydrogen around the electric arc may be recombined into atomic hydrogen or molecular hydrogen exothermically contributing to heat generation in the furnace.

In some embodiments, the furnace can be an AC or DC electric arc furnace. In some embodiments, the furnace is a modified AC or DC electric arc furnace. In some embodiments, components of the furnace can be compatible with an AC or DC electric arc furnace such that an AC or DC electric arc furnace can be retrofitted with any of the components described herein.

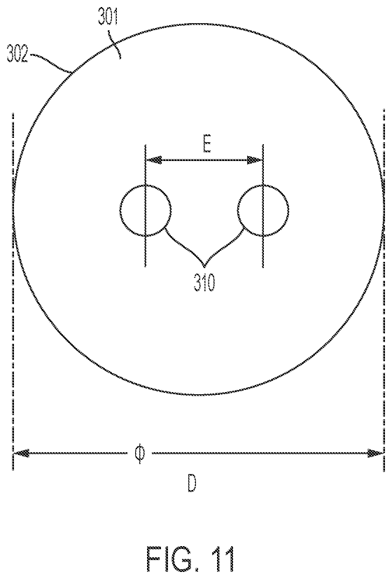

In some embodiments, at least one of the plurality of injectors can be configured to inject fluid towards and/or into the electric arc. In some embodiments, at least one of the plurality of injectors in the roof can be configured such that this plurality of injector(s) can be closer to the center of the roof and/or the at least one electrode. In some embodiments, the electrodes can be spaced apart E (FIG. 11) about 1-20 meters, about 1-15 meters, about 1-10 meters, or about 5-8 meters.

In some embodiments, the roof can include a plurality of electrodes (e.g., cathodes) that extend form the roof towards the hearth of the furnace as shown in FIGS. 10A, 10B, and 11. The configuration of the electrodes can depend on the shape of the furnace. For example, FIGS. 10A and 10B illustrate electrodes spaced along a rectangular furnace, while FIG. 11 depicts electrodes spaced in a cylindrical furnace. In some embodiments, the furnace can be configured to generate an electric arc between a distal end of each of the plurality of electrodes and at least one opposite electrode (e.g., anode(s)). In some embodiments, the distance between the plurality of electrodes is such that there may not be any electric arc interference between the electric arc of each electrode and the at least one opposite electrode. In some embodiments, the at least one electrode and/or at least one opposite electrode can be made out of carbon, graphite, titanium, tungsten, tantalum, zirconium, copper, or combinations thereof.

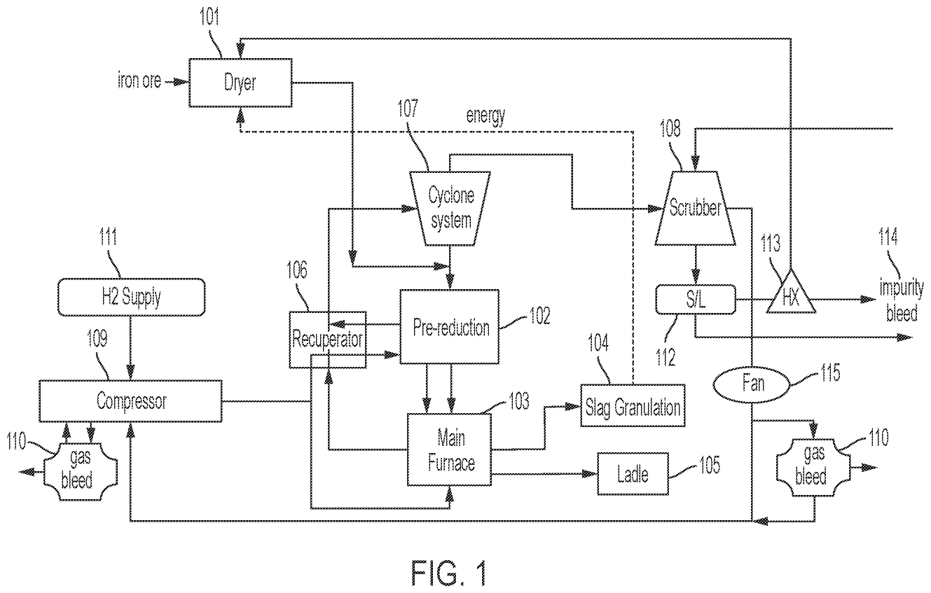

FIG. 1 illustrates an exemplary steelmaking process in accordance with some embodiments herein. As shown in FIG. 1, iron ore or a metal oxide can be introduced to a dryer 101 to remove excess water. The iron ore or metal oxide may enter the dryer directly, or it may first be mixed by iron ore dust collected through the cyclone system 107 and processed through the scrubber 108. Scrubber 108 may liberate ore and hydrogen from water vapor, deleterious minerals, or gases. Deleterious materials may include gangue elements or oxides. Gangue may include SiO₂, CaO, MgO, and Al₂O₃. Gangue and other impurities may exit through an impurity bleed 114. After exiting the scrubber, scrubbed material 112 may be separated into solid and liquid components and solid components of the scrubbed material such as iron ore dust may enter dryer 101. Dryer 101 may mix high-grade iron ore with the solid components of the scrubbed material with option of an additional heat exchanger or secondary step 113 prior to the solids entering the dryer. The processed and dried iron ore can be introduced to a pre-reduction chamber 102 to generate pre-reduced iron. For example, pre-reduction chamber 102 can be a fluidized bed, a reduction shaft, cyclone converter, spouting bed reactor, counter current shaft furnace, or any gas-solids reactor. In some embodiments, pre-reduction chamber 102 may include other equipment from traditional blast furnaces or equipment used in direct reduction of iron (DRI) processes such as a bubbling fluidized bed reactor for reducing fine iron ore or shaft furnace for pelletized iron ore. In other embodiments, the pre-reducer may be included within the main furnace. In this embodiment, the furnace can have two compartments, one upper compartment in which the off-gas flows upwards away from the arc and through a shaft above the furnace as the iron ore falls through this compartment to the bottom compartment of the furnace where smelting occurs and the final reduction stage of FeO to metallic Fe occurs. In some embodiments, these two compartments are in direct communication. In other embodiments, a heat exchanger exists between the two compartments to lower the temperature of the off-gas prior to pre-reducing the metal oxide.

Hydrogen may serve as the reducing gas in which a hydrogen supplier 111 can supply hydrogen gas/molecular hydrogen to the pre-reduction chamber 102 and a main furnace 103. Main furnace 103 can be any of the furnace embodiments described herein. The hydrogen gas/molecular hydrogen can be compressed by a compressor 109. The compressed hydrogen can enter the pre-reduction chamber 102 and the main furnace 103 along with the dried iron ore or metal oxide. In the pre-reduction chamber, hydrogen can pre-reduce the iron ore or metal oxide. In some embodiments, pre-reduction may occur through blast furnace processes or DRI processes. In the main furnace 103, pre-reduced iron ore or metal oxides, or iron ore or metal oxides from dryer 101 can be reduced in a hydrogen plasma smelting reaction (HPSR) and/or molecular hydrogen reduction reaction. HPSR can be an overall exothermic reaction, due to the exothermic recombination reaction between ionized hydrogen, and can reduce metal oxides with lower heat demand than reactions that rely solely on molecular hydrogen.

The reduced product from the main furnace 103 may be liquid iron/metal, matte, slag or steel. The reduced product can be transferred into a ladle 105. Ladle 105 can be a furnace which can refine the liquid iron/metal or steel. Slag produced from HPSR and/or molecular hydrogen reduction in the main furnace 103 can enter a slag granulation system 104. Slag granulation system 104 can atomize slag in order to release thermal energy, which can be recycled back to the dryer 101 to reduce energy consumption.

To further improve energy efficiency, residual materials from pre-reduction and HPSR and/or molecular hydrogen reduction can be recycled. Residual materials may include solids such as unreacted iron ore/metal oxides as well as off-gases, gangue elements or water vapor. Off-gases may exit the main furnace 103 or the pre-reduction chamber 102, where they can pass through a recuperator 106. Recuperator 106 can perform counter-flow heat exchange and recycle thermal energy from the off-gases. Cyclone 107 can be used to separate residual iron ore/metal oxide dust from the off-gases after the off-gases exit the recuperator 106. The residual iron-ore/metal oxides can then re-enter the pre-reduction chamber 102.

Off-gases can exit the cyclone 107 and enter scrubber 108 where hydrogen and other gases can be separated from gangue elements. After exiting the scrubber, the gases can re-enter the compressor to be used again in another reduction reaction. There may be a fan 115 which can facilitate flow of the scrubbed gases and hydrogen to the compressor. In addition, there may be gas bleeds 110 which can separate out non-condensable off-gases from hydrogen so that the non-condensable gases do not enter the main smelting reduction furnace 103. These non-condensable gases may include nitrogen, carbon dioxide, carbon monoxide, or combinations thereof.

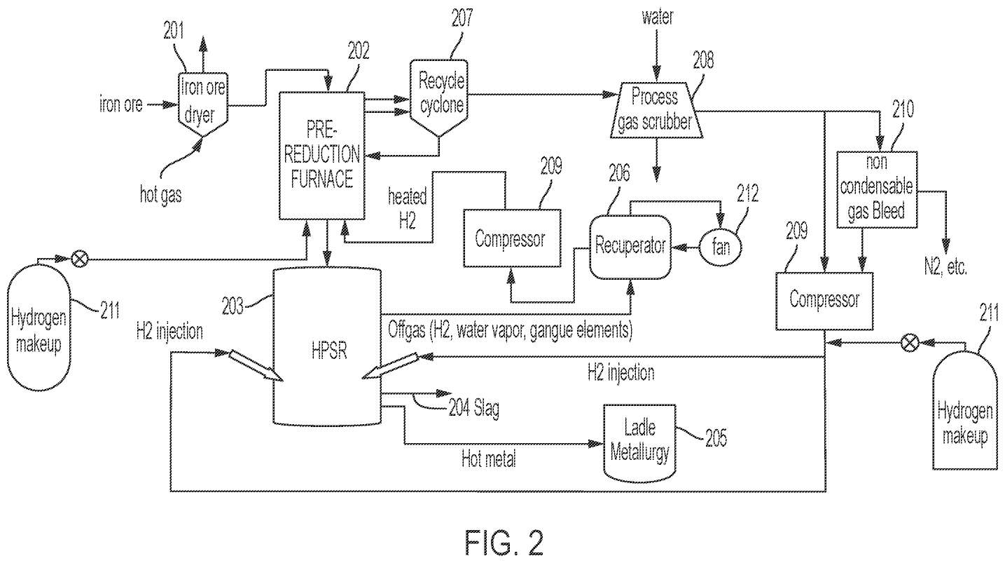

FIG. 2 illustrates another exemplary steelmaking process in accordance with some embodiments herein. As shown in FIG. 2, iron ore or metal oxide can be first introduced to a dryer 201 to remove water. The processed and dried iron ore can then be introduced to a pre-reduction chamber 202 to generate pre-reduced iron. For example, pre-reduction chamber 202 can be a fluidized bed, including bubbling or circulation, a reduction shaft, a cyclone converter, a spouted bed reactor, or a counter current shaft furnace. In some embodiments, pre-reduction chamber 202 may include other equipment from blast furnaces or equipment used in direct reduction of iron (DRI) processes.

Hydrogen can be introduced from a hydrogen supplier 211 to the pre-reduction chamber 202. A hydrogen supplier 211 may also introduce hydrogen to be injected into a main furnace 203.

Main furnace 203 may include any of the furnace embodiments described herein. In some embodiments, hydrogen introduced by the hydrogen supplier may enter pre-reduction chamber 202 or main furnace 203 without being compressed by a compressor 209.

In main furnace 203, pre-reduced iron ore or metal oxides can be reduced by the injected hydrogen via HPSR and/or a molecular hydrogen reduction reaction. HPSR can be an exothermic reaction and can occur without the need for additional heat. The reduced product from the main furnace 203 may be liquid iron/metal or steel. The reduced product can be transferred into a ladle 205. Ladle 205 can be a furnace which can refine the liquid iron/metal or steel. Slag 204 may also be produced from the main furnace 203 and thermal energy from the slag 204 may or may not be recycled.

To further improve energy efficiency, residual materials from pre-reduction and HPSR and/or molecular hydrogen reduction can be recycled. Residual materials may include solids such as unreacted iron ore/metal oxides as well as off-gases, including unreacted hydrogen, gangue elements or water vapor. Off-gases may exit the main furnace 203 where they can pass through a recuperator 206 which can perform counter-flow heat exchange and recycle thermal energy from the off-gases. A fan 212 may facilitate with cycling off-gases through the recuperator 206. Hydrogen may exit the recuperator 206 and may be pressurized and heated before being recycled into the pre-reduction chamber 202.

Off-gases and residual solids may exit the pre-reduction chamber 202 and may enter a cyclone 207. Cyclone 207 can be used to separate residual iron ore/metal oxides from the off-gases and recycle the residual iron ore/metal oxides and off-gases. Residual iron-ore/metal oxides can then re-enter the pre-reduction chamber 202. Off-gases may exit the cyclone 207 and may enter a scrubber 208. Scrubber 208 may separate hydrogen from non-condensable gases. These non-condensable gases may include nitrogen and carbon dioxide. Non-condensable gases may exit through a gas bleed 210, while the recycled hydrogen can enter a compressor 209 before injection into main furnace 203.

In another embodiment, the high temperature water vapor exiting the reactor or the pre-reduction chamber can be directed to a steam electrolyzer (aka solid oxide electrolyzer (SOEC)) for further hydrogen production. Prior to the SOEC, the off-gas may be scrubbed of the gangue elements to avoid poisoning of the SOEC. The hydrogen produced through the SOEC is then directed back to the reactor for metal oxide reduction.

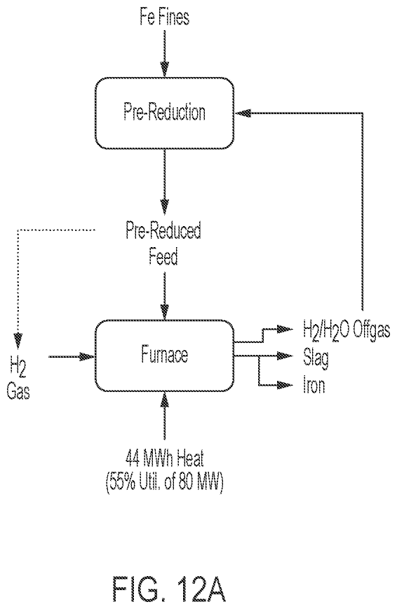

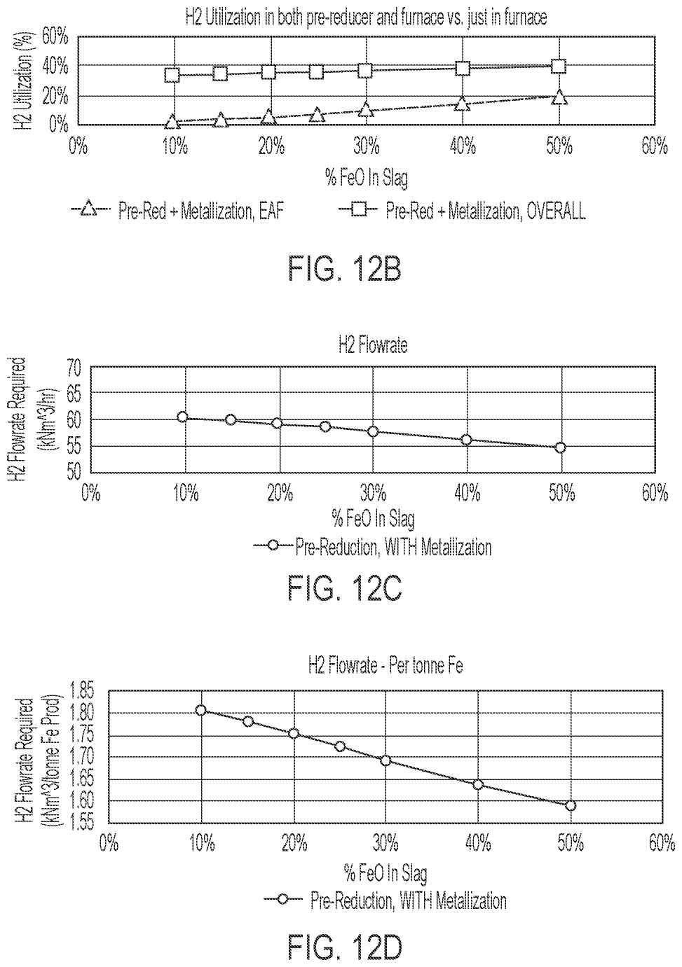

FIG. 12A illustrates an exemplary hydrogen utilization flowchart in accordance with some embodiments herein and FIGS. 12B-D illustrate exemplary hydrogen utilization and flowrate charts associated with the hydrogen utilization flowchart. More specifically, FIG. 12A illustrates example iron production characteristics for 200,000 tonnes per year production in single-electrode furnace with an unoptimized flowsheet and without a gas preheater. An 80 MW electric arc furnace, hydrogen, and water vapor from a pre-reduction furnace can be sent to the main electric arc furnace (EAF). In pre-reduction before the furnace, iron ore can be partially metallized to iron. H₂ gas can be heated in the EAF. Gas for pre-reduction can enter at about 800-1000° C. (˜900° C.) and exit at about 200-400° C. (˜300° C.). The solids (e.g., iron ore) in the pre-reduction stage can enter at about 20-30°° C. (˜25° C.) and exit at about 600-800°° C. (˜700°° C.). The EAF can heat the solids from 700 to about 1600-1700° C. (˜1625° C.).

In some embodiments, the methods described herein may be applied to batch, continuous, or semi-continuous production of metal from metal oxides. In some embodiments, a high weight-percentage of metal oxide is maintained in the slag to increase the hydrogen utilization degree of the process, according to the exemplary charts in FIG. 12B. The metal layer below the slag can be continuously or batch-wise tapped. Once a critical volume of high metal-oxide containing slag is produced, an increased volume of reductant (e.g. hydrogen) can be injected into the slag to convert the remaining oxide in the slag into metallic. The slag can then tapped be, and the cycle can begin again with a high weight percentage of metal oxide being maintained in the slag for the majority of the operation.

In some embodiments, there are at least two of the furnaces described herein in communication. In the first furnace, a high metal-oxide containing slag can be maintained above the metal layer, to maximize the hydrogen utilization during operation. The slag from the first furnace can then be transferred to the second furnace, in which a reductant can be injected into the slag to recover the metal from the metal oxide in the slag (e.g. FeO to Fe). Both furnaces may or may not employ an electric arc to produce ionized hydrogen and/or supply heat to the furnace.

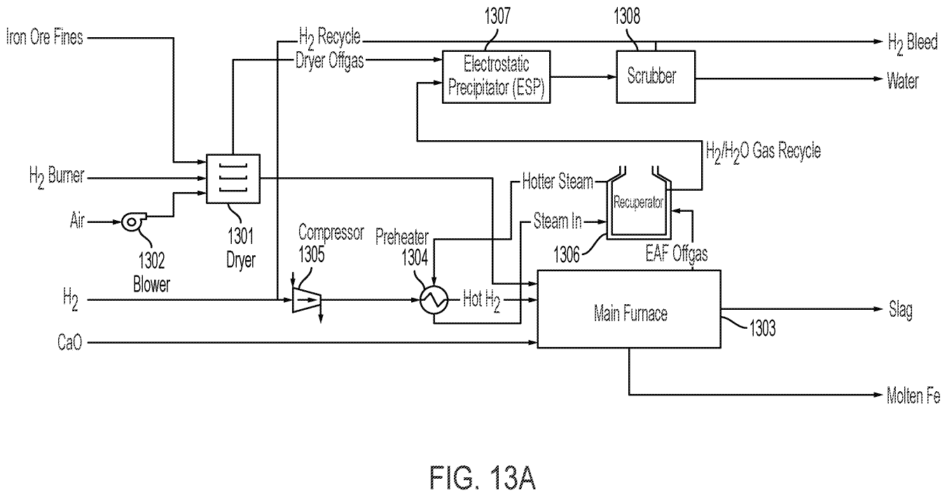

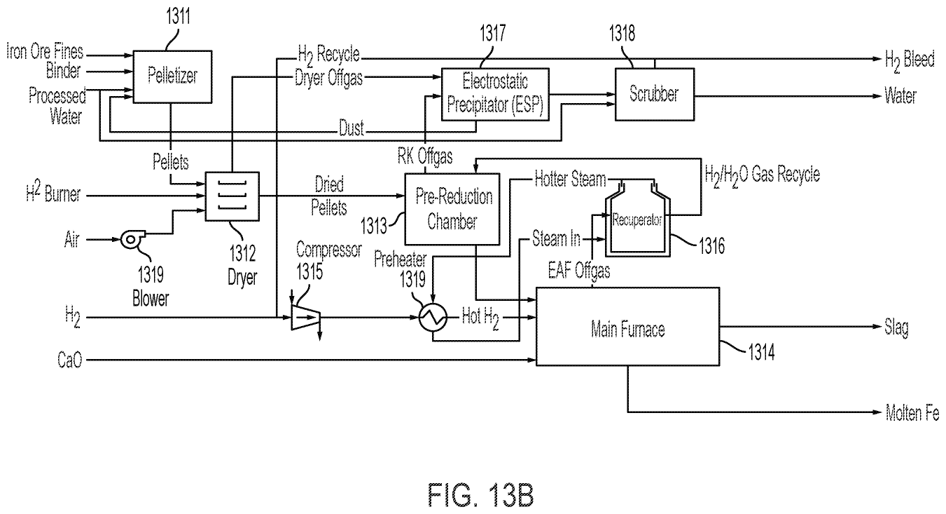

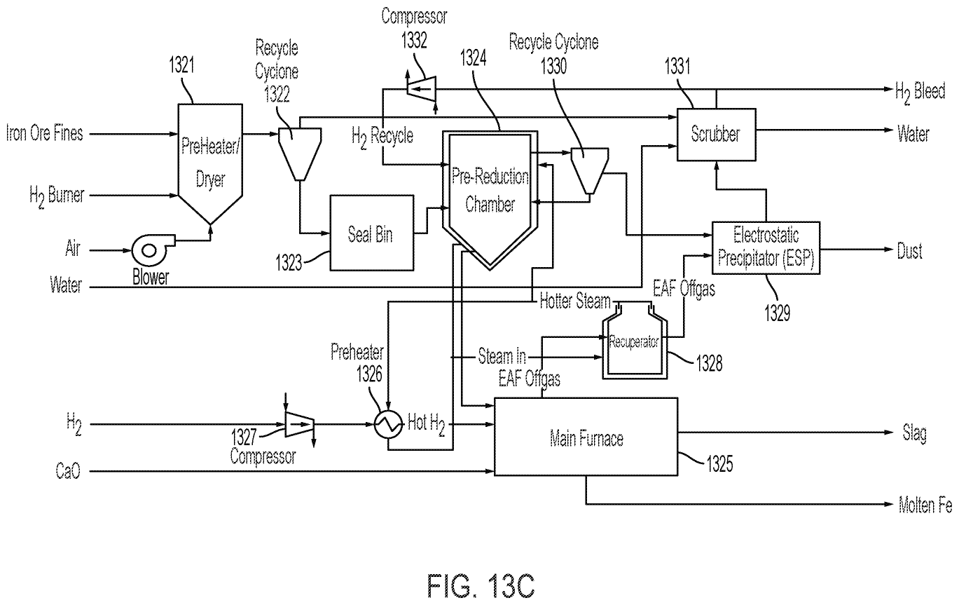

FIG. 13A illustrates an exemplary steelmaking process in accordance with some embodiments herein. As shown in FIG. 13A, iron ore or a metal oxide, in the form of fines, lumps, pellets, etc., can be introduced to a dryer 1301 to remove excess water. The dryer 1301 can be heated by a hydrogen-fueled burner, for example. For iron ore or metal oxide fines, the dryer 1301 may be a fluidized bed. In some embodiments, the dried iron ore or metal oxide can be introduced directly into the main furnace 1303. Within the main furnace 1303, the iron ore or metal oxide may be reduced into metallic metal. Unreduced metal and gangue elements or oxides from the ore may be tapped from the furnace as slag. The oxides introduced into the furnace 1303 may be reduced by hydrogen or hydrogen mixtures (e.g., molecular hydrogen, hydrogen plasma, hydrogen-argon mixtures, hydrogen-nitrogen mixtures), which may be preheated through a preheater 1304. The hydrogen may be compressed by compressor 1305 beyond ambient pressure prior to introduction to the furnace 1303 or preheater 1304. The compressed or uncompressed hydrogen may be introduced into the furnace 1303 through ports around the furnace, lances or gas injectors, which may introduce the hydrogen directly into the slag bath or above the slag bath. The hydrogen may additionally or alternatively be introduced through a hollow electrode in the furnace 1303. The hydrogen introduced into the furnace may come into contact with the electric arc in the furnace, thereby generating hydrogen plasma (i.e. ionized hydrogen). The ionized hydrogen may then react with the metal oxide to reduce the metal oxide.

To maximize thermodynamic efficiency and minimize operational costs, the heat from the main furnace 1303 may be recovered. The offgas from the furnace 1303 can be introduced into a recuperator 1306 or other type of heat exchanger or heat recovery boiler. The recovered heat from the recuperator 1306 can be used to preheat the hydrogen or other reducing gas in the preheater 1304. The lower temperature offgas from the recuperator 1306 can be introduced into, for example, an electrostatic precipitator 1307. The electrostatic precipitator 1307 can separate residual metal oxide dust from the offgas, which can then be re-introduced into the dryer 1301 or furnace 1303. The electrostatic precipitator 1307 can be heated using the offgas from the dryer 1301. The offgas can then be introduced into a gas scrubber and/or condenser 1308, wherein the remaining hydrogen can be separated from the water vapor. Other gases present in the offgas, such as SOx or NOx, may additionally or alternatively be separated from the offgas through the scrubber 1308.

In another embodiment, scrap metal can be added to the main furnace 1303 in addition to iron ore, thereby producing steel. In yet another embodiment, iron tapped from the main furnace 1303 is introduced into a ladle furnace in which it is refined into steel. In yet another embodiment, carbon is introduced into the main furnace 1304 in accordance to the steel alloy composition desired. The introduced carbon dissolves into the iron bath, and steel is tapped from the main furnace 1304.

FIG. 13B illustrates yet another exemplary steelmaking process in accordance with some embodiments. As shown in FIG. 13B, iron ore or metal oxide can be first introduced to a pelletizer 1311 to bind the ore or oxides together into a pellet. The pelletized iron ore or metal oxides can then be introduced to a dryer 1312 to remove moisture, including crystallic water. The pelletized and dried iron ore can then be introduced to a pre-reduction chamber 1313 to generate pre-reduced iron oxide. The pre-reduction chamber 1313 may be a shaft furnace, rotary kiln, or alternative furnace embodiment. In some embodiments, pre-reduction chamber 1313 may include other equipment from blast furnaces or equipment used in direct reduction of iron (DRI) processes.

Hydrogen can be introduced from a hydrogen supplier to the pre-reduction chamber 1313. A hydrogen supplier may additionally or alternatively introduce hydrogen for injection into a main furnace 1314. Main furnace 1314 may include any of the furnace embodiments described herein. In some embodiments, hydrogen introduced by the hydrogen supplier may enter pre-reduction chamber 1313 or main furnace 1314 without being compressed by a compressor 1315 or preheated by a preheater 1319.

In main furnace 1314, pre-reduced iron ore or metal oxides can be reduced by the injected hydrogen via hydrogen plasma smelting reduction (HPSR) and/or molecular hydrogen reduction reaction. The reduced product from the main furnace 1314 may be liquid iron/metal or steel. Slag may also be produced from the main furnace 1314 and thermal energy from the slag may or may not be recycled.

To further improve energy efficiency, residual materials from pre-reduction and HPSR and/or molecular hydrogen reduction can be recycled. Residual materials may include solids such as unreacted iron ore/metal oxides as well as off-gases, including unreacted hydrogen, gangue elements or water vapor. Off-gases may exit the main furnace 1314 where they can pass through a recuperator 1316 which can perform counter-flow heat exchange and/or recycle thermal energy from the off-gases. Hydrogen may exit the recuperator 1316 and recycled into the pre-reduction chamber 1313. The thermal energy recovered from the recuperator 1316 may be used to preheat hydrogen from the hydrogen supplier and/or preheat the hydrogen recycled after the pre-reduction chamber 1313.

Off-gases and residual solids may exit the pre-reduction chamber 1313 and may enter a electrostatic precipitator 1317. Electrostatic precipitator 1317 can be used to separate residual iron ore/metal oxides from the off-gases and recycle the residual iron ore/metal oxides and off-gases.

Residual iron-ore/metal oxides can then re-enter the pelletizer 1311. Off-gases may exit the electrostatic precipitator 1317 and may enter a scrubber and/or condenser 1318. Scrubber 1318 may separate hydrogen from non-condensable gases. Non-condensable gases may include but are not limited to nitrogen and carbon dioxide. Non-condensable gases may exit through a gas bleed, while the recycled hydrogen may enter a compressor 1315 before injection into main furnace 1314.

FIG. 13C illustrates yet another exemplary steelmaking process in accordance with some embodiments herein. As shown in FIG. 13C, iron ore or a metal oxide can be introduced to a preheater or dryer 1321 to remove excess water and/or preheat the material. The iron ore or metal oxide may enter the dryer directly, or in some embodiments it may first be mixed by iron ore dust collected through a cyclone system 1322 and processed through a scrubber/condenser 1331. Scrubber 1331 may liberate ore and hydrogen from water vapor, deleterious minerals, and/or gases. Deleterious materials may include but are not limited to gangue elements or oxides, such as SiO₂, CaO, MgO, and/or Al₂O₃. Gangue and other impurities may exit through an impurity bleed. Iron ore or metal oxide following the recycle cyclone 1322 may be introduced into a seal bin 1323 in which the iron ore or metal oxide fines may be mixed with fluxes. The mixed feed may then be introduced into a pre-reduction chamber 1324 to generate pre-reduced iron or pre-reduced metal oxides. Iron ore fines or metal oxide fines of small diameter may be recycled through a cyclone 1330 and back into the pre-reduction chamber 1324. For example, pre-reduction chamber 1324 can be a fluidized bed, a reduction shaft, cyclone converter, spouting bed reactor, counter current shaft furnace, or any gas-solids reactor. In some embodiments, pre-reduction chamber 1324 may include other equipment from traditional blast furnaces or equipment used in direct reduction of iron (DRI) processes, such as a bubbling fluidized bed reactor for reducing fine iron ore. In some embodiments, the pre-reduction chamber 1324 may be incorporated within the main furnace 1325. In some embodiments, the main furnace 1325 may have two compartments, for example, an upper compartment in which the off-gas flows upwards away from the arc and through a shaft above the furnace, and the iron ore falls through the upper compartment to the bottom compartment of the furnace where smelting can occur and the final reduction stage of FeO to metallic Fe can occur. In some embodiments, these two compartments are in direct communication. In other embodiments, a heat exchanger 1328 may exist between the two compartments, for example, to lower the temperature of the off-gas prior to pre-reducing the metal oxide.

Hydrogen may serve as the reducing gas in which a hydrogen supplier can supply hydrogen gas/molecular hydrogen to the pre-reduction chamber 1324 and a main furnace 1325. Main furnace 1325 can be any of the furnace embodiments described herein. The hydrogen gas/molecular hydrogen can be compressed by a compressor 1327. The compressed hydrogen can enter the main furnace 1325 along with the dried iron ore or metal oxide. In some embodiments, the compressed hydrogen is first preheated 1326 prior to entering the main furnace 1325. In the pre-reduction chamber 1324, hydrogen can pre-reduce the iron ore or metal oxide. In the main furnace 1325, pre-reduced iron ore or metal oxides, or iron ore or metal oxides from dryer 1321, can be reduced in a hydrogen plasma smelting reaction (HPSR) and/or molecular hydrogen reduction reaction. HPSR can reduce metal oxides with lower heat demand than reactions that rely solely on molecular hydrogen.

The reduced product from the main furnace 1325 may be liquid iron/metal, matte, slag or steel. The reduced product can be transferred into a ladle furnace which can refine the liquid iron/metal or steel. Slag produced from HPSR and/or molecular hydrogen reduction in the main furnace 1325 can enter a slag granulation system.

To further improve energy efficiency, residual materials from pre-reduction chamber 1324 and the main furnace 1325 can be recycled. Residual materials may include solids such as unreacted iron ore/metal oxides as well as off-gases, gangue elements or water vapor. Off-gases may exit the main furnace 1325 and/or the pre-reduction chamber 1324, where they can pass through a recuperator 1328. Recuperator 1328 can perform counter-flow heat exchange and recycle thermal energy from the off-gases to pre-heat hydrogen or other reduction gases in a preheater 1326. Electrostatic precipitator 1329 can be used to separate residual iron ore/metal oxide dust from the off-gases after the off-gases exit the recuperator 1328.

Off-gases can exit the electrostatic precipitator 1329 and enter scrubber/condenser 1331, where hydrogen and other gases can be separated from gangue elements and/or water vapor. After exiting the scrubber 1331, the gases can re-enter the compressor 1332 to be used again in another reduction reaction in the pre-reduction chamber 1324.

### DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

1. A furnace, comprising:
a shell defining an inner volume;
an injector extending into the inner volume of the shell;
a feed port disposed in a top portion of the shell, the feed port configured allow introduction of an oxide feed into the furnace; and
a hearth disposed in a bottom portion of the inner volume, the hearth configured to receive the oxide feed and contain a molten bath, the molten bath including a layer of metal product and a layer of slag;
wherein the injector is configured to inject a fluid into the molten bath.

2. The furnace of claim 1, wherein the fluid comprises at least one of hydrogen gas, a hydrogen-containing gas, or a carbon-containing gas.

3. The furnace of claim 1, wherein the fluid comprises a mixture of hydrogen gas and nitrogen gas.

4. The furnace of claim 1, wherein the injector is configured to inject a carbon source into the molten bath for carburization.

5. The furnace of claim 1, wherein the injector is configured to inject the fluid into the layer of slag.

6. The furnace of claim 1, wherein a distal portion of the injector is submerged in the molten bath.

7. The furnace of claim 6, wherein the distal portion of the injector is submerged in the layer of slag.

8. The furnace of claim 6, wherein the distal portion of the injector enters the molten bath at a non-perpendicular angle.

9. The furnace of claim 8, wherein the injector is configured to impart a swirling motion to at least a portion of the molten bath within the furnace.

10. A furnace, comprising:
a shell defining an inner volume;
an injector extending into the inner volume of the shell;
a feed port disposed in a top portion of the shell, the feed port configured allow introduction of an oxide feed into the furnace; and
a hearth disposed in a bottom portion of the inner volume, the hearth configured to receive the oxide feed and contain a molten bath, the molten bath including a layer of metal product and a layer of slag;
wherein a distal portion of the injector is at least partially submerged in the layer of slag and is configured to inject a fluid into the layer of metal product.

11. The furnace of claim 10, wherein the injector comprises at least one of a lance, a supersonic jet, a coherent jet, or a plasma torch.

12. The furnace of claim 11, wherein the injector is a plasma torch and the plasma torch injects the fluid at a temperature greater than a melting point of the oxide feed.

13. The furnace of claim 10, wherein the oxide feed comprises a metal oxide.

14. The furnace of claim 13, wherein the metal oxide comprises at least one of iron oxide, hematite, magnetite, or iron oxide-containing waste streams.

15. The furnace of claim 10, wherein the layer of metal product comprises metallic iron.

16. The furnace of claim 10, further comprising:
a first electrode at least partially embedded in the hearth; and
a second electrode disposed in a center region of the furnace, the first and the second electrodes configured to generate an arc between the first electrode and the second electrode, the arc configured to ionize at least a portion of the fluid injected by the injector to produce an ionized gas that reduces the oxide feed.

17. The furnace of claim 16, wherein a distal end of the second electrode is disposed above the layer of slag.

18. The furnace of claim 16, wherein a distal end of the second electrode is submerged in the molten bath.

19. The furnace of claim 16, wherein the arc is configured to at least partially melt the oxide feed.

20. The furnace of claim 16, wherein the second electrode comprises a channel, the fluid being further injected into the furnace through the channel.

21. A furnace, comprising:
a shell defining an inner volume;
an injector extending into the inner volume of the shell;
a feed port disposed in a top portion of the shell, the feed port configured allow introduction of an oxide feed into the furnace;
a hearth disposed in a bottom portion of the inner volume, the hearth configured to receive the oxide feed and contain a molten bath, the molten bath including a layer of metal product and a layer of slag;
a first electrode disposed in a center region of the furnace; and
a second electrode at least partially embedded in the hearth, the first electrode and the second electrode configured to generate an arc between the first and second electrodes, wherein the injector is configured to inject a fluid into the molten bath.

22. The furnace of claim 21, wherein the injector is configured to inject the fluid into the layer of slag.

23. The furnace of claim 21, wherein a distal portion of the injector is submerged in the molten bath.

24. The furnace of claim 23, wherein the distal portion of the injector enters the molten bath at a non-perpendicular angle.

25. The furnace of claim 21, wherein the fluid comprises at least one of hydrogen gas, a hydrogen-containing gas, or a carbon-containing gas.

26. The furnace of claim 21, wherein the fluid comprises a mixture of hydrogen gas and nitrogen gas.

27. The furnace of claim 21, wherein the injector is configured to inject a carbon source into the molten bath for carburization.

28. The furnace of claim 21, wherein the oxide feed comprises a metal oxide.

29. The furnace of claim 21, wherein the shell comprises a heat exchanger to regulate furnace temperature.

30. The furnace of claim 29, wherein the heat exchanger includes water-cooled copper.
